(19) United States
(12) Patent Application Publication
(10) Pub. No.: US 2014/0325437 A1
(43) Pub. Date: Oct. 30, 2014

(54) CONTENT DELIVERY SYSTEM WITH USER INTERFACE MECHANISM AND METHOD OF OPERATION THEREOF

(71) Applicant: Samsung Electronics Co., Ltd., Gyeonggi-Do (KR)

(72) Inventors: Eric Pacenta, San Francisco, CA (US); Nina F. Shih, Mountain View, CA (US); Daniel William Simmons, San Francisco, CA (US); Seungeun Lee, Sunnyvale, CA (US); Yun Z. Wu, San Francisco, CA (US); Weng Chi Lou, Lisboa (PT); Michael Baisuck, San Jose, CA (US)

(73) Assignee: Samsung Electronics Co., Ltd., Gyeonggi-Do (KR)

(21) Appl. No.: 13/870,872

(22) Filed: Apr. 25, 2013

(51) Int. Cl. G06F 3/0482

(52) U.S. Cl. CPC G06F 3/0482
USPC 715/793

(57) ABSTRACT

A content delivery system includes: a background provider configured to provide a background interface; a pane provider module, coupled to the background provider module, configured to provide a pane interface having a non-horizontal slant side overlapping the background interface; and a menu provider module, coupled to the pane provider module, configured to provide a menu interface having a slant menu side overlapping the non-horizontal slant side of the pane interface creating a blade non-right angle for displaying on a device.

### TECHNICAL FIELD

An embodiment of the present invention relates generally to a content delivery system, and more particularly to a system for user interface mechanism.

### BACKGROUND

Modem portable consumer and industrial electronics, especially client devices such as navigation systems, cellular phones, portable digital assistants, and combination devices are providing increasing levels of functionality to support modem life including location-based information services. Research and development in the existing technologies can take a myriad of different directions.

As users become more empowered with the growth of mobile location based service devices, new and old paradigms begin to take advantage of this new device space. There are many technological solutions to take advantage of this new device location opportunity. One existing approach is to use location information to provide personalized content through a mobile device, such as a cell phone, smart phone, or a personal digital assistant.

Personalized content services allow users to create, transfer, store, and/or consume information in order for users to create, transfer, store, and consume in the “real world.” One such use of personalized content services is to efficiently transfer or guide users to the desired product or service.

Thus, a need still remains for a content delivery system with user interface mechanism for aiding the consumption of information. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a content delivery system including: a background provider module configured to provide a background interface; a pane provider module, coupled to the background provider module, configured to provide a pane interface having a non-horizontal slant side overlapping the background interface; and a menu provider module, coupled to the pane provider module, configured to provide a menu interface having a slant menu side overlapping the non-horizontal slant side of the pane interface creating a blade non-right angle for displaying on a device.

An embodiment of the present invention provides a method of operation of a content delivery system including: receiving a gesture type on a blade interface; generating an interface group based on an interface type of the blade interface; and modifying a blade dimension of the blade interface based on the gesture type with a control unit for displaying on a device.

An embodiment of the present invention provides a content delivery system including an user interface including: a background interface; a pane interface having a non-horizontal slant side overlapping the background interface; and a menu interface having a slant menu side overlapping the non-horizontal slant side of the pane interface creating a blade non-right angle for displaying on a device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a content delivery system with user interface mechanism in an embodiment of the present invention.

FIG. 2 is examples of a blade interface displayed on a display interface of the first device.

FIG. 3 is examples of the background interface.

FIG. 4 is examples of the menu interface of FIG. 2.

FIG. 5 is first examples of the pane interface.

FIG. 6 is second examples of the pane interface.

FIG. 7 is examples of the blade interface of FIG. 2 organized in an interface group.

FIG. 8 is first examples of a gesture type.

FIG. 9 is a second example of the gesture type.

FIG. 10 is an exemplary block diagram of the content delivery system.

FIG. 11 is a control flow of the content delivery system.

FIG. 12 is a flow chart of a method of operation of a content delivery system in an embodiment of the present invention.

### DETAILED DESCRIPTION

The following embodiments of the present invention provides a blade interface, such as a background interface, a menu interface, a pane interface, as an user interface for a device. The blade interface can receive a gesture type to modify a blade dimension of the blade interface for displaying on the device. Further, the blade interface can overlap one another to display a portion of the blade interface overlapped.

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “relevant information” referred to herein includes the navigation information described as well as information relating to points of interest to the user, such as local business, hours of businesses, types of businesses, advertised specials, traffic information, maps, local events, and nearby community or personal information.

The term “module” referred to herein can include software, hardware, or a combination thereof in the embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

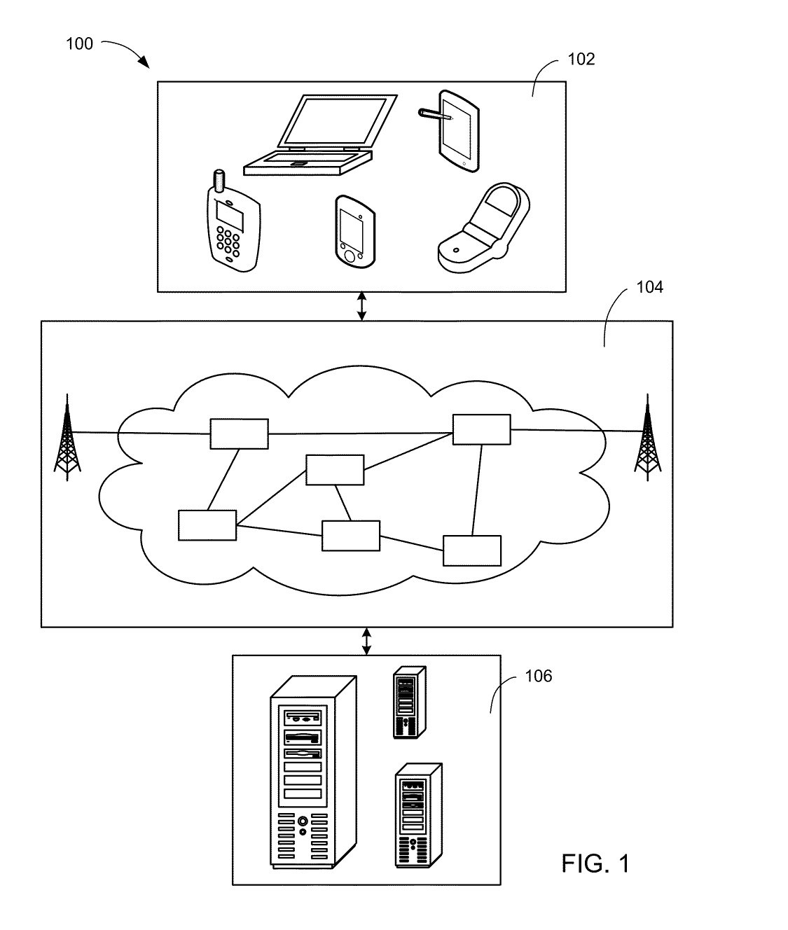

Referring now to FIG. 1, therein is shown a content delivery system 100 with user interface mechanism in an embodiment of the present invention. The content delivery system 100 includes a first device 102, such as a client or a server, connected to a second device 106, such as a client or server. The first device 102 can communicate with the second device 106 with a communication path 104, such as a wireless or wired network.

For example, the first device 102 can be of any of a variety of display devices, such as a cellular phone, personal digital assistant, wearable digital device, tablet, notebook computer, television (TV), automotive telematic communication system, or other multi-functional mobile communication or entertainment device. The first device 102 can be a standalone device, or can be incorporated with a vehicle, for example a car, truck, bus, aircraft, boat/vessel, or train. The first device 102 can couple to the communication path 104 to communicate with the second device 106.

For illustrative purposes, the content delivery system 100 is described with the first device 102 as a display device, although it is understood that the first device 102 can be different types of devices. For example, the first device 102 can also be a non-mobile computing device, such as a server, a server farm, or a desktop computer.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102.

In another example, the first device 102 can be a particularized machine, such as a mainframe, a server, a cluster server, rack mounted server, or a blade server, or as more specific examples, an IBM System z10™ Business Class mainframe or a HP ProLiant ML™ server. Yet another example, the second device 106 can be a particularized machine, such as a portable computing device, a thin client, a notebook, a netbook, a smartphone, personal digital assistant, or a cellular phone, and as specific examples, an Apple iPhone™, Android™ smartphone, or Windows™ platform smartphone.

For illustrative purposes, the content delivery system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example a car, truck, bus, aircraft, boat/vessel, or train.

Also for illustrative purposes, the content delivery system 100 is shown with the second device 106 and the first device 102 as end points of the communication path 104, although it is understood that the content delivery system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, wireless High-Definition Multimedia Interface (HDMI), Near Field Communication (NFC), Infrared Data Association standard (IrDA), wireless fidelity (WiFi), and worldwide interoperability for microwave access (WiMAX) are examples of wireless communication that can be included in the communication path 104. Ethernet, HDMI, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

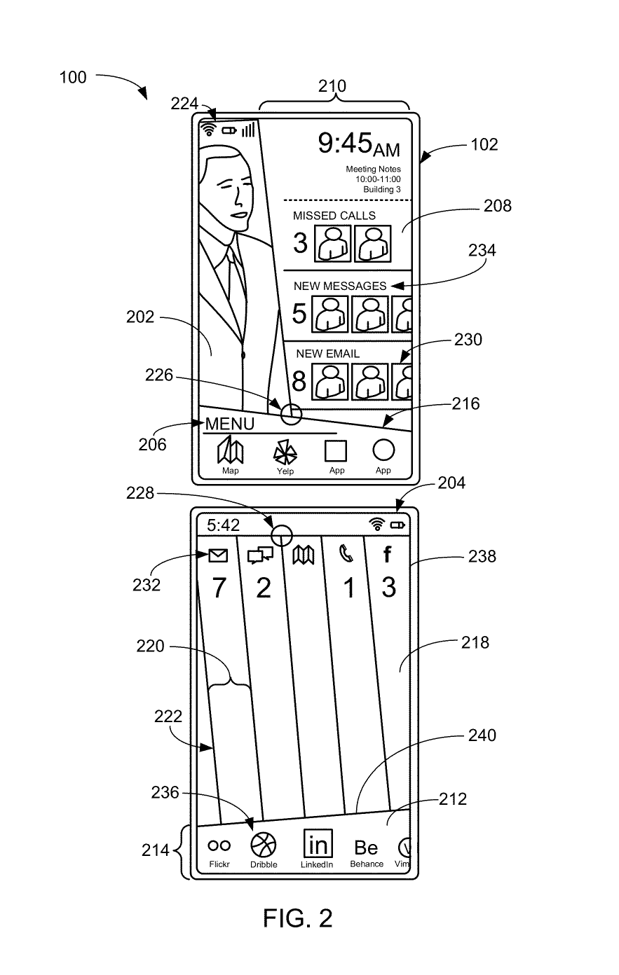

Referring now to FIG. 2, therein is shown examples of a blade interface 202 displayed on a display interface 204 of the first device 102. The blade interface 202 is a graphical user interface for accessing the content displayed on the display interface 204. For clarity and brevity, the discussion of the present invention will focus on the first device 102 displaying the result generated by the content delivery system 100. However, the second device 106 and the first device 102 can be discussed interchangeably.

The blade interface 202 can include a variety of an interface type 206. The interface type 206 is a classification of the blade interface 202. For example, the interface type 206 can include a background interface 208. The background interface 208 is the blade interface 202 that is persistently available on the display interface 204. More specifically, the persistent availability can represent that a blade dimension 210 of the background interface 208 can remain unmodified. The blade dimension 210 is a property of a surface area of the blade interface 202. For example, the blade dimension 210 can represent the height, width, length, thickness, or a combination thereof of the blade interface 202.

For another example, the interface type 206 can include a menu interface 212. The menu interface 212 is the blade interface 202 available from an extent of the display interface 204. For example, the menu interface 212 can be available from a bottom extent of the display interface 204. A menu dimension 214 is a property of a surface area of the menu interface 212. For example, the menu dimension 214 can represent the height, width, length, thickness, or a combination thereof of the menu interface 212.

The menu interface 212 can have a slant menu side 216 at a top extent, a bottom extent, a side extent, or a combination thereof of the menu interface 212. For example, the slant menu side 216 at the top extent of the menu interface 212 can be not parallel to a display side 238 representing a top extent, a bottom extent, or a combination thereof of the display interface 204. Furthermore, the slant menu side 216 at the top extent of the menu interface 212 can be not perpendicular to the display side 238 representing a left extent, a right extent, or a combination thereof. The display side 238 is a borderline that establishes the perimeter of the display interface 204.

For another example, the interface type 206 can include a pane interface 218. The pane interface 218 is the blade interface 202 displayable with more than one instance. For example, the display interface 204 can display a plurality of the pane interface 218 adjacent to one another of the pane interface 218. More specifically, a pane dimension 220 of the pane interface 218 can have a non-horizontal slant side 222 at a left extent, a right extent, or a combination thereof of the pane interface 218. The non-horizontal slant side 222 can extend towards the top extent and the bottom extent of the display interface 204. Moreover, the non-horizontal slant side 222 can be not parallel to the display side 238 representing a left extent, a right extent, or a combination thereof of the display interface 204. Furthermore, the non-horizontal slant side 222 can be not perpendicular to the display side 238 representing a top extent, a bottom extent, or a combination thereof.

The pane interface 218 can also have a top slant pane side 224 at a top extent of the pane interface 218 and a bottom slant pane side 240 at a bottom extent of the pane interface 218. The top slant pane side 224, the bottom slant pane side 240, or a combination thereof can be not parallel to the display side 238 representing a left extent, a right extent, or a combination thereof of the display interface 204. Furthermore, the top slant pane side 224, the bottom slant pane side 240, or a combination thereof can be not perpendicular to the display side 238 representing a top extent, a bottom extent, or a combination thereof.

Moreover, one instance of the pane interface 218 can overlap along the non-horizontal slant side 222 of another instance of the pane interface 218. For a different example, one instance of the pane interface 218 can contiguously connect along the non-horizontal slant side 222 of another instance of the pane interface 218. The pane dimension 220 is a property of a surface area of the pane interface 218. For example, the pane dimension 220 can represent the height, width, length, thickness, or a combination thereof of the pane interface 218.

A blade non-right angle 226 is an angle created after one instance of the blade interface 202 overlapped another instance of the blade interface 202. The blade non-right angle 226 can represent an angle between 0 degrees to 89 degrees, 91 degrees to 179 degrees, or a combination thereof. For example, the menu interface 212 can overlap the pane interface 218. The blade non-right angle 226 can be created where the slant menu side 216 at the top extent of the menu interface 212 overlaps the non-horizontal slant side 222 of the pane interface 218.

A side non-right angle 228 is an angle created after the blade interface 202 reaches the extent of the display interface 204. The side non-right angle 228 can represent an angle between 0 degrees to 89 degrees, 91 degrees to 179 degrees, or a combination thereof. For example, the side non-right angle 228 when the non-horizontal slant side 222 of the pane interface 218 reaches the top extent of the display interface 204 can be at 75 degrees. For another example, the side non-right angle 228 of the slant menu side 216 at the top extent of the menu interface 212 reaching the left extent of the display interface 204 can be at 80 degrees.

The blade interface 202 can display a variety of a content type 230. The content type 230 is a category of content displayed on the blade interface 202. For example, the content type 230 can include a feature icon 232, communication information 234, or a combination thereof. The feature icon 232 is a selectable image for invoking the service available on the first device 102. For example, the feature icon 232 can include an application icon 236. The application icon 236 is a selectable image for invoking the software application installed on the first device 102. For a specific example, the background interface 208 can display the application icon 236 for changing the brightness of the display interface 204. For another example, the menu interface 212 can display the application icon 236 for Yelp!™, an American directory and rating website.

The background interface 208, the pane interface 218, or a combination thereof can display the communication information 234. The communication information 234 is a communication record received, sent, or a combination thereof from or to the first device 102. The communication information 234 can include missed calls, new messages, new emails, comments exchanged, or a combination.

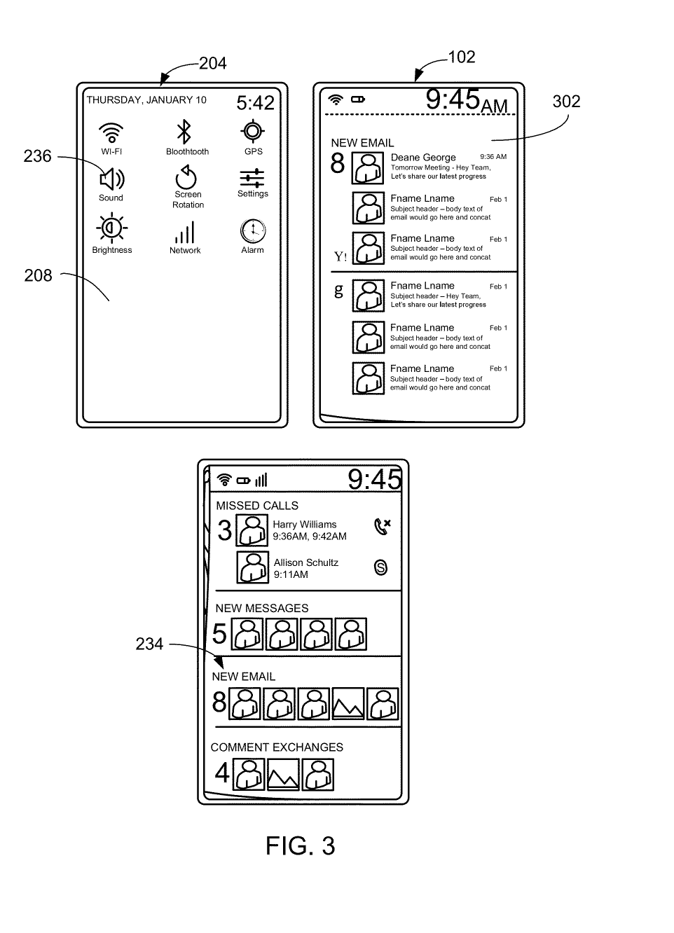

Referring now to FIG. 3, therein is shown examples of the background interface 208. For example, the background interface 208 can be displayed on the display interface 204 without the menu interface 212 of FIG. 2, the pane interface 218 of FIG. 2, or a combination thereof. As discussed previously, the background interface 208 can display the content type 230 of FIG. 2 representing the feature icon 232 of FIG. 2. More specifically, the feature icon 232 can represent the application icon 236. Moreover, the application icon 236 can represent the setting icon to control the configuration of the first device 102.

For another example, the background interface 208 can include a channel interface 302. The channel interface 302 is a subinterface of the background interface 208. The channel interface 302 can be independent from the background interface 208 or provided within the background interface 208. For example, the user can select the communication information 234 displayed on the background interface 208. More specifically, the communication information 234 selected can represent the communication record for new email. After the selection, the display interface 204 can display the channel interface 302 for the communication information 234 representing the new email.

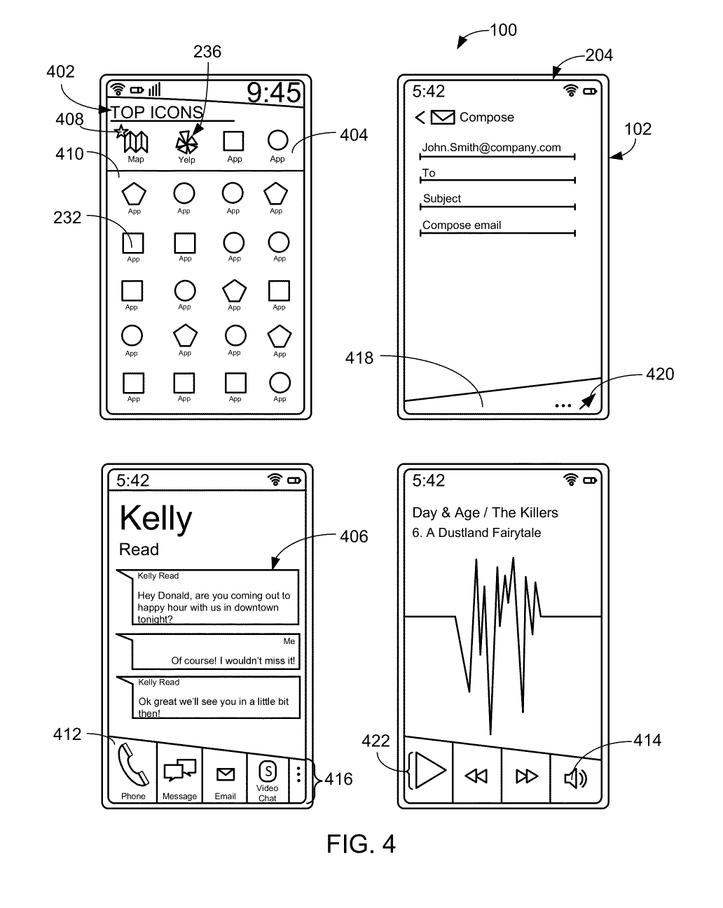

Referring now to FIG. 4, therein is shown examples of the menu interface 212 of FIG. 2. For example, the menu interface 212 can be displayed on the display interface 204 without the background interface 208 of FIG. 2, the pane interface 218 of FIG. 2, or a combination thereof. The menu interface 212 can include a variety of a menu type 402. The menu type 402 is a category of a subinterface for the menu interface 212.

The menu type 402 can include a headline menu 404. The headline menu 404 is a subinterface of the menu interface 212 for displaying a select instance of the feature icon 232. The select instance of the feature icon 232 can represent the feature icon 232 selected by the content delivery system 100 out of all instances of the feature icon 232 based on considering various factors. The headline menu 404 can be independent from the menu interface 212 or provided within the menu interface 212. For example, the various factors can include an activity record 406, an icon priority 408, or a combination thereof.

The activity record 406 is history of the user using the first device 102. For example, the activity record 406 can represent the number of frequency of use for the application icon 236 by the user. The icon priority 408 is an order of importance placed on the feature icon 232. For example, the icon priority 408 with the highest importance can be placed on the headline menu 404 based on the activity record 406 for the highest number of usage.

The menu type 402 can include a feature menu 410. The feature menu 410 is a subinterface of the menu interface 212 for displaying all instances of the feature icon 232. The feature menu 410 can be independent from the menu interface 212 or provided within the menu interface 212. The display interface 204 can display the headline menu 404, the feature menu 410, or a combination thereof.

The menu type 402 can include a tool interface 412. The tool interface 412 is a subinterface of the menu interface for displaying a tool icon 414. The tool icon 414 is a selectable image for controlling the software application after the software application has been invoked. The tool interface 412 can be independent from the menu interface 212 or provided within the menu interface 212. For example, the tool icon 414 can represent an audio control for audio music application, such as play, fast forward, rewind, change volume, or a combination thereof. For another example, the tool icon 414 can represent a communication control for initiating a communication, such calling, texting, emailing, or a combination thereof.

The tool interface 412 can have a tool menu dimension 416. The tool menu dimension 416 is a property of a surface area for the tool interface 412. For example, the tool menu dimension 416 can represent the height, width, length, thickness, or a combination thereof of the tool interface 412.

The menu type 402 can include an indicator menu 418. The indicator menu 418 is a subinterface of the menu interface 212 for displaying an icon indicator 420. The icon indicator 420 is a selectable image representing a shortcut for accessing the feature icon 232. The indicator menu 418 can be independent from the menu interface 212 or provided within the menu interface 212.

The feature icon 232 can have an icon dimension 422. The icon dimension 422 is a property of a surface area for the feature icon 232. For example, the icon dimension 422 can represent the height, width, length, thickness, or a combination thereof of the feature icon 232.

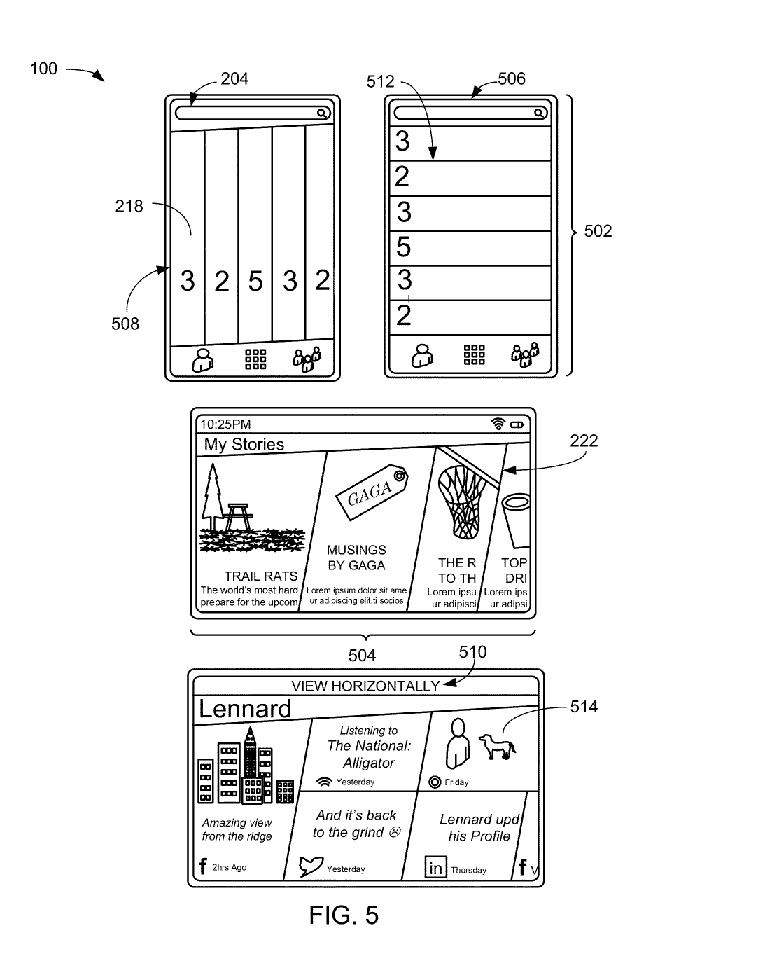

Referring now to FIG. 5, therein is shown first examples of the pane interface 218. The display interface 204 can be displayed as a vertical display orientation 502 or a horizontal display orientation 504. The vertical display orientation 502 is having a short side 506 of the display interface 204 as the top extent or the bottom extent of the display interface 204. The horizontal display orientation 504 is having a long side 508 of the display interface 204 as the top extent or the bottom extent of the display interface 204. The display side 238 of FIG. 2 can represent the short side 506, the long side 508, or a combination thereof. The long side 508 can represent the display side 238 longer in length than the short side 506.

The blade interface 202 of FIG. 2 can be displayed as the vertical display orientation 502 or the horizontal display orientation 504 based on a display rule 510. For example, the background interface 208 of FIG. 2, the menu interface 212 of FIG. 2, the pane interface 218, or a combination thereof can be displayed as he vertical display orientation 502 or the horizontal display orientation 504. The display rule 510 is a constraint placed on the content delivery system 100 for displaying the blade interface 202. For example, the pane interface 218 can have a pane side 512 perpendicular to the display side 238 representing the top extent of the display interface 204 for the vertical display orientation 502. The pane interface 218 can have the pane side 512 parallel to the display side 238 representing the top extent of the display interface 204 for the horizontal display orientation 504. Furthermore, a plurality of the pane interface 218 can be contiguously connected to each other along the pane side 512. For a different example, one instance of the pane interface 218 can overlap another instance of the pane interface 218 along the pane side 512.

For another example, the pane interface 218 can have a subpane interface 514. The subpane interface 514 is a subinterface of the pane interface 218. The subpane interface 514 can be independent from the pane interface 218 or provided within the pane interface 218. For a specific example, a plurality of the subpane interface 514 can be provided within the pane interface 218.

For further example, a plurality of the subpane interface 514 can share the non-horizontal slant side 222 of the pane interface 218. Further, the plurality of the subpane interface 514 can share the pane side 512 parallel to the bottom extent of the display interface 204. The pane interface 218 can have the non-horizontal slant side 222, the pane side 512, or a combination thereof displayed on the display interface 204.

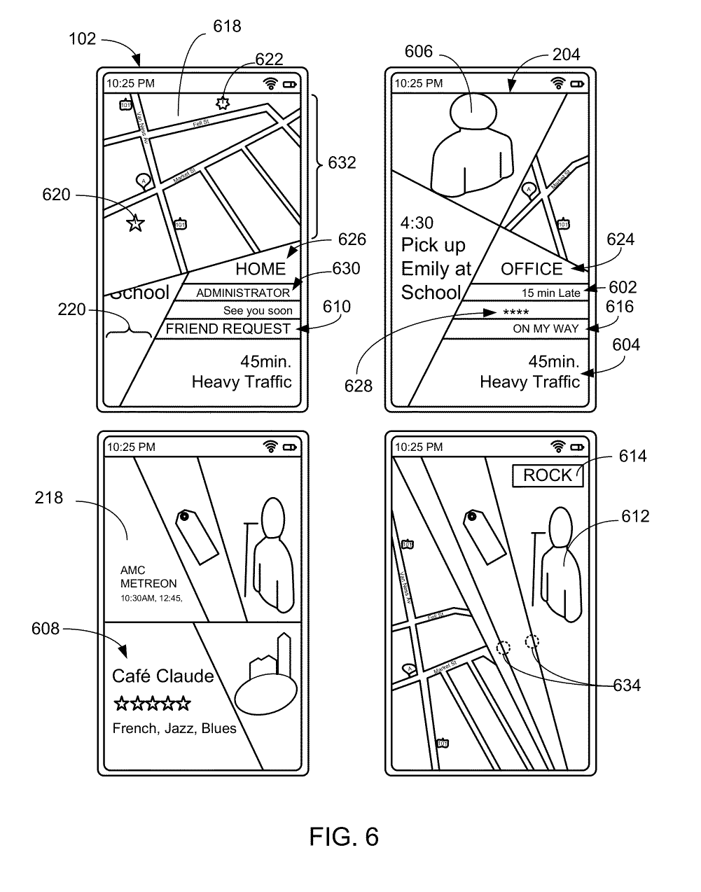

Referring now to FIG. 6, therein is shown second examples of the pane interface 218. The pane interface 218 can display a variety of the content type 230 of FIG. 2. For example, the content type 230 can include time information 602, navigation information 604, profile information 606, a category of interest 608, social media information 610, entertainment information 612, or a combination thereof.

The time information 602 can include a schedule on a calendar, a time of day, or a combination thereof. The navigation information 604 can include guidance and route for reaching a point of interest. The profile information 606 can represent personal information, such as the name, age, birthday, sex, marital status, race, occupation, or a combination thereof. The category of interest 608 can represent a classification of the point of interest. The social media information 610 can represent an online interaction on a social networking site.

The entertainment information 612 can represent a content related to a performing art. A genre type 614 is a categorization of the entertainment information 612. For example, the entertainment information 612 can represent music. The genre type 614 can include rock music, rap music, classical music, or jazz music.

The pane interface 218 can display the content type 230 based on a context 616. The context 616 is a situation, environment, or a combination thereof where the user of the first device 102 is situated. For example, the context 616 can consist of various instances of an environmental condition 618. For example, the environmental condition 618 can include a weather condition, a noise level, or a combination thereof surrounding a current location 620 of the first device 102, an other user's location 622, or a combination thereof. The other user's location 622 can represent the physical location of a person other than the user of the first device 102.

The environmental condition 618 can include a private environment 624, a public environment 626, or a combination thereof. The private environment 624 can represent a place or situation where other people cannot see the user or the display interface 204 of the first device 102. The public environment 626 can represent a place or situation where other people can see the user or the display interface 204 of the first device 102.

A privacy setting 628 is a restriction for accessing the first device 102. For example, in the context 616 under the public environment 626, the privacy setting 628 can be configured to restrict the display of the profile information 606 related to the user of the first device 102 on the display interface 204. The privacy setting 628 can be configured to restrict the display of the content type 230 by modifying the blade dimension 210 of FIG. 2. More specifically, the pane interface 218 displaying the profile information 606 can have the pane dimension 220 narrower than the pane interface 218 displaying the navigation information 604.

A user type 630 is a categorization of the user who is allow to access the first device 102. For example, the user type 630 can represent a guest. For another example, the user type 630 can represent a user with administrative privileges to change the setting or configuration of the first device 102.

A content priority 632 is a level of importance placed on the content type 230. For example, the higher the content priority 632 is, the bigger the pane dimension 220 can be to display the content type 230. For another example, the higher the content priority 632 is, the closer to the top extent of the display interface 204 that the pane interface 218 can be placed for displaying the content type 230.

For further example, a side number 634 of the blade dimension 210 can change based on the content priority 632. The side number 634 of three can represent the blade dimension 210 representing a polygon having three sides. The side number 634 of five can represent the blade dimension 210 representing the polygon having five sides. For a specific example, the higher the content priority 632 is, the more of the side number 634 that the pane dimension 220 can have to display the content type 230.

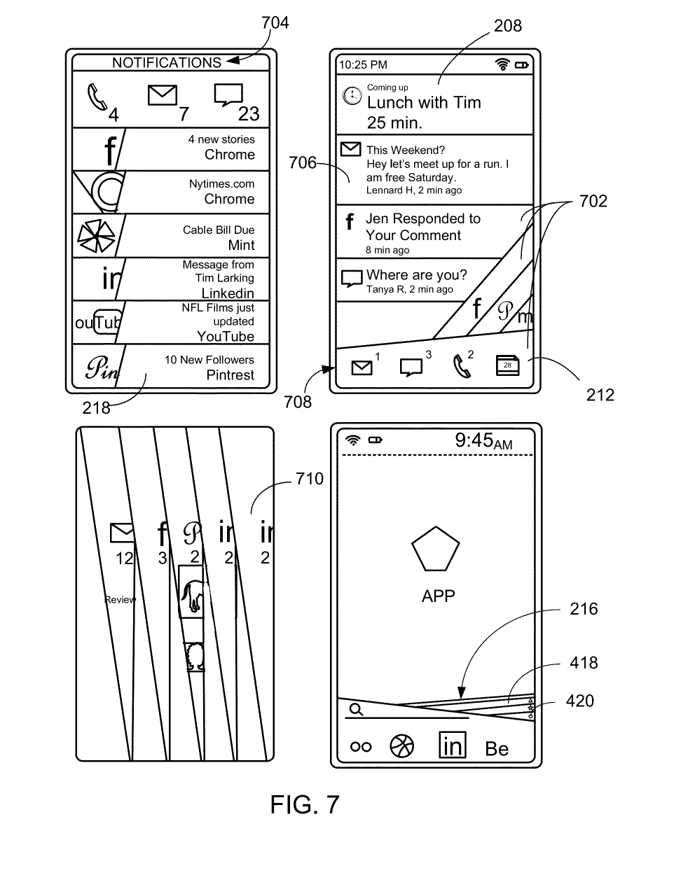

Referring now to FIG. 7, therein is shown examples of the blade interface 202 of FIG. 2 organized in an interface group 702. The interface group 702 is an arrangement of a plurality of the blade interface 202. For example, the background interface 208, the menu interface 212, the pane interface 218, or a combination thereof can be grouped based on an interface relationship 704 to generate the interface group 702.

The interface relationship 704 is a constraint to associate the plurality of the blade interface 202 to one another of the blade interface 202. The interface relationship 704 can be established amongst the background interface 208, the menu interface 212, the pane interface 218, or a combination thereof. More specifically, the interface relationship 704 can establish the relationship amongst the instances of the blade interface 202 as a parent interface 706, a child interface 708, or a combination thereof.

The parent interface 706 is a base interface. The base interface can represent the blade interface 202 where further selection of another instance of the blade interface 202 to access the content is unavailable. For example, the blade dimension 210 of the parent interface 706 can be not modifiable. The child interface 708 is a non-base interface. The non-base interface can represent the blade interface 202 where further selection of another instance of the blade interface 202 to access the content is available. For example, the blade dimension 210 of the child interface 708 can be modifiable. A pane indicator 710 is a shortcut for accessing the pane interface 218.

A plurality of the indicator menu 418 can be displayed on the display interface 204 of FIG. 2. More specifically, the background 208 can display the application currently running on the first device 102 of FIG. 1. Each of the plurality of the indicator menu 418 can display the recently opened application. The recently opened application can represent the application that ran previous to the application currently running on the first device 102. The indicator menu 418 can display the icon indicator 420 for the user to access the application represented by the application icon 236 of FIG. 2 displayed on the indicator menu 418. Furthermore, the slant menu side 216 at the top extent of the menu interface 212 can overlap the slant menu side 216 at the top extent of the indicator menu 418 creating the blade non-right angle 226 of FIG. 2.

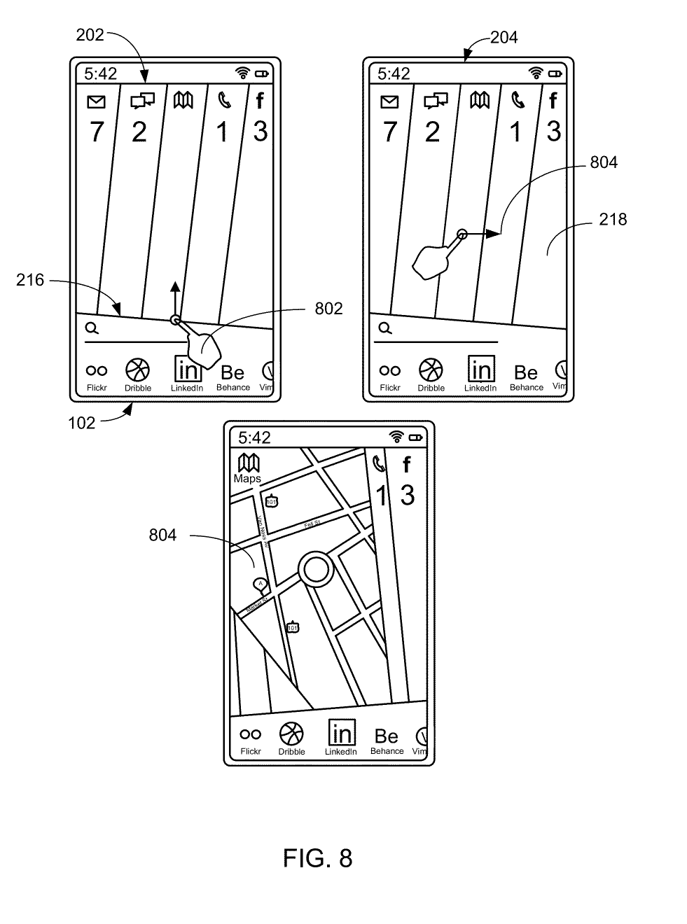

Referring now to FIG. 8, therein is shown first examples of a gesture type 802. The gesture type 802 is an entry type to the first device 102. For example, the gesture type 802 can include a press gesture, a fling gesture, a zigzag gesture, a pinch gesture, or a combination thereof. The first device 102 can receive the gesture type 802 on the blade interface 202 displayed on the first device 102.

The press gesture can represent a motion where the user presses down, for example, on the blade interface 202 displayed on the display interface 204. Duration of time for pressing down, for example, can range from 0.5 second to 1 second, which can be longer than touching the surface with a tap. The fling gesture can represent the motion where the user swipes towards one direction having contact with the display interface 204. The zigzag gesture can represent the motion where the user contacts the display interface 204 in a series of sharp turns.

The pinch gesture can represent a motion where the user uses two or more fingers to perform a motion of squeezing or expanding by contacting the display interface 204. The tap gesture can represent a motion where the user contacts the display interface 204 for less than 0.5 second. Further, the double tap gesture can represent a motion where the user contacts the display interface 204 for less than 0.5 second consecutively. The dragging gesture can represent the motion where the user drags the surface of the blade interface 202.

For example, the user can perform the gesture type 802 of the dragging gesture on the slant menu side 216 at the top extent of the menu interface 212 towards the top extent of the display interface 204 to overlap the pane interface 218. The user can perform the gesture type 802 of the fling gesture to scroll the pane interface 218 in a scroll direction 804 of right. The scroll direction 804 is a movement of the blade interface 202 in response to the gesture type 802. For another example, the user can perform the gesture type 802 representing the press gesture to view a content preview 806. The content preview 806 is a sneak peek of the content displayable on the blade interface 202.

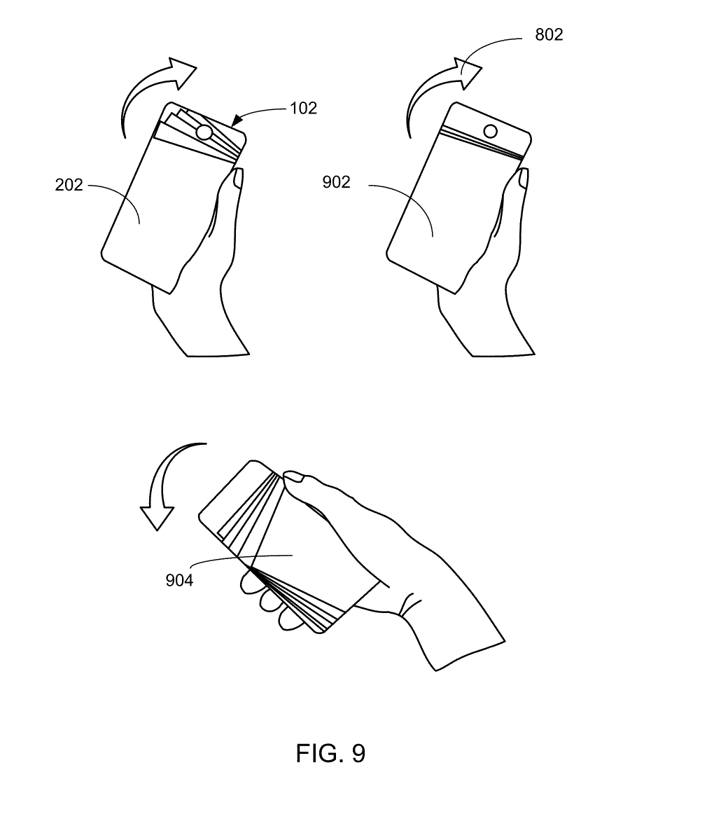

Referring now to FIG. 9, therein is shown a second example of the gesture type 802. For example, the gesture type 802 can represent the shake gesture. The user can perform the shake gesture by tilting the first device 102 up and down. More specifically, the user can perform the shake gesture to modify the display of a plurality of the blade interface 202 displayed in a stack mode 902, an expand mode 904, or a combination thereof.

The stack mode 902 is a display mode of the blade interface 202 where a plurality of the blade interface 202 is stacked on top of each other. More specifically, the blade dimension 210 of FIG. 2 of the blade interface 202 under the top instance of the blade interface 202 can be covered by more than 50% of the surface area in the stack mode 902. The expand mode 904 is the display mode of the blade interface 202 where the plurality of the blade interface 202 is unstacked. More specifically, the blade dimension 210 of the blade interface 202 under the top instance of the blade interface 202 can be covered by less than 50% of the surface area in the expand mode 904.

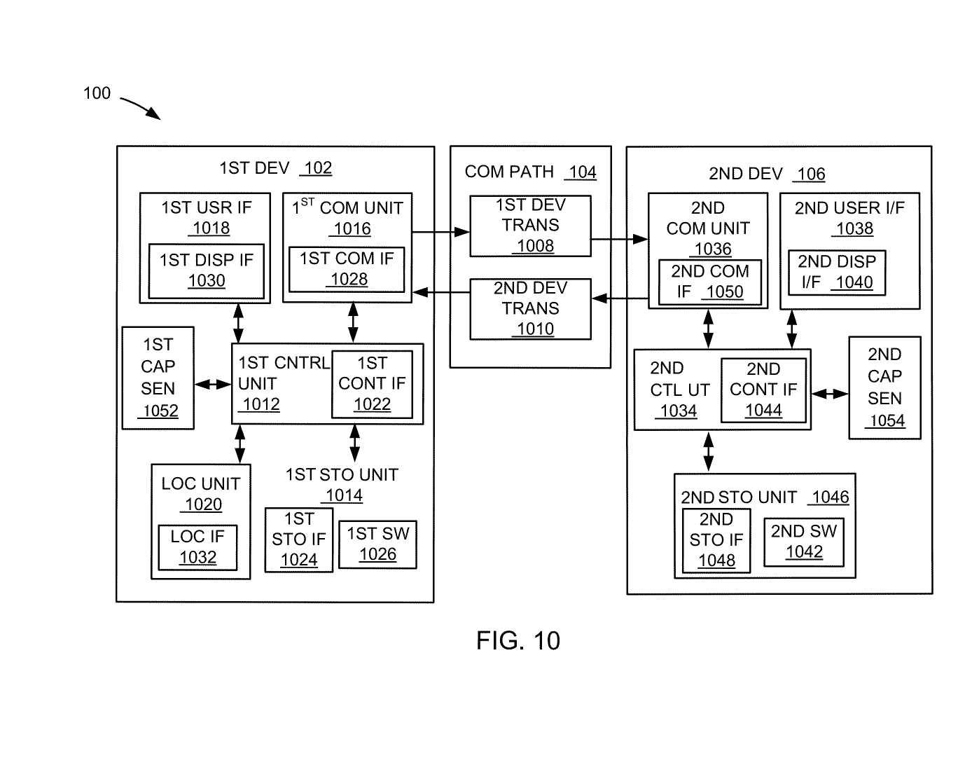

Referring now to FIG. 10, therein is shown an exemplary block diagram of the content delivery system 100. The content delivery system 100 can include the first device 102, the communication path 104, and the second device 106. The first device 102 can send information in a first device transmission 1008 over the communication path 104 to the second device 106. The second device 106 can send information in a second device transmission 1010 over the communication path 104 to the first device 102.

For illustrative purposes, the content delivery system 100 is shown with the first device 102 as a client device, although it is understood that the content delivery system 100 can have the first device 102 as a different type of device. For example, the first device 102 can be a server having a display interface.

Also for illustrative purposes, the content delivery system 100 is shown with the second device 106 as a server, although it is understood that the content delivery system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of the present invention.

The first device 102 can include a first control unit 1012, a first storage unit 1014, a first communication unit 1016, a first user interface 1018, and a location unit 1020. The first control unit 1012 can include a first control interface 1022. The first control unit 1012 can execute a first software 1026 to provide the intelligence of the content delivery system 100.

The first control unit 1012 can be implemented in a number of different manners. For example, the first control unit 1012 can be a processor, an application specific integrated circuit (ASIC) an embedded processor, a microprocessor, a hardware control logic, a hardware finite state machine (FSM), a digital signal processor (DSP), or a combination thereof. The first control interface 1022 can be used for communication between the first control unit 1012 and other functional units in the first device 102. The first control interface 1022 can also be used for communication that is external to the first device 102.

The first control interface 1022 can receive information from the other functional units or from external sources, or can transmit information to the other functional units or to external destinations. The external sources and the external destinations refer to sources and destinations physically separate from to the first device 102.

The first control interface 1022 can be implemented in different ways and can include different implementations depending on which functional units or external units are being interfaced with the first control interface 1022. For example, the first control interface 1022 can be implemented with a pressure sensor, an inertial sensor, a microelectromechanical system (MEMS), optical circuitry, waveguides, wireless circuitry, wireline circuitry, or a combination thereof.

The location unit 1020 can generate location information, current heading, and current speed of the first device 102, as examples. The location unit 1020 can be implemented in many ways. For example, the location unit 1020 can function as at least a part of a global positioning system (GPS), an inertial navigation system, a cellular-tower location system, a pressure location system, or any combination thereof.

The location unit 1020 can include a location interface 1032. The location interface 1032 can be used for communication between the location unit 1020 and other functional units in the first device 102. The location interface 1032 can also be used for communication that is external to the first device 102.

The location interface 1032 can receive information from the other functional units or from external sources, or can transmit information to the other functional units or to external destinations. The external sources and the external destinations refer to sources and destinations physically separate from the first device 102.

The location interface 1032 can include different implementations depending on which functional units or external units are being interfaced with the location unit 1020. The location interface 1032 can be implemented with technologies and techniques similar to the implementation of the first control interface 1022.

The first storage unit 1014 can store the first software 1026. The first storage unit 1014 can also store the relevant information, such as advertisements, points of interest (POI), navigation routing entries, or any combination thereof. The relevant information can also include news, media, events, or a combination thereof from the third party content provider.

The first storage unit 1014 can be a volatile memory, a nonvolatile memory, an internal memory, an external memory, or a combination thereof. For example, the first storage unit 1014 can be a nonvolatile storage such as non-volatile random access memory (NVRAM), Flash memory, disk storage, or a volatile storage such as static random access memory (SRAM).

The first storage unit 1014 can include a first storage interface 1024. The first storage interface 1024 can be used for communication between and other functional units in the first device 102. The first storage interface 1024 can also be used for communication that is external to the first device 102.

The first storage interface 1024 can receive information from the other functional units or from external sources, or can transmit information to the other functional units or to external destinations. The external sources and the external destinations refer to sources and destinations physically separate from the first device 102.

The first storage interface 1024 can include different implementations depending on which functional units or external units are being interfaced with the first storage unit 1014. The first storage interface 1024 can be implemented with technologies and techniques similar to the implementation of the first control interface 1022.

The first communication unit 1016 can enable external communication to and from the first device 102. For example, the first communication unit 1016 can permit the first device 102 to communicate with the second device 106 of FIG. 1, an attachment, such as a peripheral device or a computer desktop, and the communication path 104.

The first communication unit 1016 can also function as a communication hub allowing the first device 102 to function as part of the communication path 104 and not limited to be an end point or terminal unit to the communication path 104. The first communication unit 1016 can include active and passive components, such as microelectronics or an antenna, for interaction with the communication path 104.

The first communication unit 1016 can include a first communication interface 1028. The first communication interface 1028 can be used for communication between the first communication unit 1016 and other functional units in the first device 102. The first communication interface 1028 can receive information from the other functional units or can transmit information to the other functional units.

The first communication interface 1028 can include different implementations depending on which functional units are being interfaced with the first communication unit 1016. The first communication interface 1028 can be implemented with technologies and techniques similar to the implementation of the first control interface 1022.

The first user interface 1018 allows a user (not shown) to interface and interact with the first device 102. The first user interface 1018 can include an input device and an output device. Examples of the input device of the first user interface 1018 can include a keypad, a touchpad, soft-keys, a keyboard, a microphone, an infrared sensor for receiving remote signals, or any combination thereof to provide data and communication inputs.

The first user interface 1018 can include a first display interface 1030. The first display interface 1030 can include a display, a projector, a video screen, a speaker, or any combination thereof.

The first control unit 1012 can operate the first user interface 1018 to display information generated by the content delivery system 100. The first control unit 1012 can also execute the first software 1026 for the other functions of the content delivery system 100, including receiving location information from the location unit 1020. The first control unit 1012 can further execute the first software 1026 for interaction with the communication path 104 via the first communication unit 1016.

The second device 106 can be optimized for implementing the embodiment of the present invention in a multiple device embodiment with the first device 102. The second device 106 can provide the additional or higher performance processing power compared to the first device 102. The second device 106 can include a second control unit 1034, a second communication unit 1036, and a second user interface 1038.

The second user interface 1038 allows a user (not shown) to interface and interact with the second device 106. The second user interface 1038 can include an input device and an output device. Examples of the input device of the second user interface 1038 can include a keypad, a touchpad, soft-keys, a keyboard, a microphone, or any combination thereof to provide data and communication inputs. Examples of the output device of the second user interface 1038 can include a second display interface 1040. The second display interface 1040 can include a display, a projector, a video screen, a speaker, or any combination thereof.

The second control unit 1034 can execute a second software 1042 to provide the intelligence of the second device 106 of the content delivery system 100. The second software 1042 can operate in conjunction with the first software 1026. The second control unit 1034 can provide additional performance compared to the first control unit 1012.

The second control unit 1034 can operate the second user interface 1038 to display information. The second control unit 1034 can also execute the second software 1042 for the other functions of the content delivery system 100, including operating the second communication unit 1036 to communicate with the first device 102 over the communication path 104.

The second control unit 1034 can be implemented in a number of different manners. For example, the second control unit 1034 can be a processor, an embedded processor, a microprocessor, hardware control logic, a hardware finite state machine (FSM), a digital signal processor (DSP), or a combination thereof.

The second control unit 1034 can include a second control interface 1044. The second control interface 1044 can be used for communication between the second control unit 1034 and other functional units in the second device 106. The second control interface 1044 can also be used for communication that is external to the second device 106.

The second control interface 1044 can receive information from the other functional units or from external sources, or can transmit information to the other functional units or to external destinations. The external sources and the external destinations refer to sources and destinations physically separate from the second device 106.

The second control interface 1044 can be implemented in different ways and can include different implementations depending on which functional units or external units are being interfaced with the second control interface 1044. For example, the second control interface 1044 can be implemented with a pressure sensor, an inertial sensor, a microelectromechanical system (MEMS), optical circuitry, waveguides, wireless circuitry, wireline circuitry, or a combination thereof.

A second storage unit 1046 can store the second software 1042. The second storage unit 1046 can also store the relevant information, such as advertisements, points of interest (POI), navigation routing entries, or any combination thereof. The second storage unit 1046 can be sized to provide the additional storage capacity to supplement the first storage unit 1014.

For illustrative purposes, the second storage unit 1046 is shown as a single element, although it is understood that the second storage unit 1046 can be a distribution of storage elements. Also for illustrative purposes, the content delivery system 100 is shown with the second storage unit 1046 as a single hierarchy storage system, although it is understood that the content delivery system 100 can have the second storage unit 1046 in a different configuration. For example, the second storage unit 1046 can be formed with different storage technologies forming a memory hierarchal system including different levels of caching, main memory, rotating media, or off-line storage.

The second storage unit 1046 can be a volatile memory, a nonvolatile memory, an internal memory, an external memory, or a combination thereof. For example, the second storage unit 1046 can be a nonvolatile storage such as non-volatile random access memory (NVRAM), Flash memory, disk storage, or a volatile storage such as static random access memory (SRAM).

The second storage unit 1046 can include a second storage interface 1048. The second storage interface 1048 can be used for communication between other functional units in the second device 106. The second storage interface 1048 can also be used for communication that is external to the second device 106.

The second storage interface 1048 can receive information from the other functional units or from external sources, or can transmit information to the other functional units or to external destinations. The external sources and the external destinations refer to sources and destinations physically separate from the second device 106.

The second storage interface 1048 can include different implementations depending on which functional units or external units are being interfaced with the second storage unit 1046. The second storage interface 1048 can be implemented with technologies and techniques similar to the implementation of the second control interface 1044.

The second communication unit 1036 can enable external communication to and from the second device 106. For example, the second communication unit 1036 can permit the second device 106 to communicate with the first device 102 over the communication path 104.

The second communication unit 1036 can also function as a communication hub allowing the second device 106 to function as part of the communication path 104 and not limited to be an end point or terminal unit to the communication path 104. The second communication unit 1036 can include active and passive components, such as microelectronics or an antenna, for interaction with the communication path 104.

The second communication unit 1036 can include a second communication interface 1050. The second communication interface 1050 can be used for communication between the second communication unit 1036 and other functional units in the second device 106. The second communication interface 1050 can receive information from the other functional units or can transmit information to the other functional units.

The second communication interface 1050 can include different implementations depending on which functional units are being interfaced with the second communication unit 1036. The second communication interface 1050 can be implemented with technologies and techniques similar to the implementation of the second control interface 1044.

The first communication unit 1016 can couple with the communication path 104 to send information to the second device 106 in the first device transmission 1008. The second device 106 can receive information in the second communication unit 1036 from the first device transmission 1008 of the communication path 104.

The second communication unit 1036 can couple with the communication path 104 to send information to the first device 102 in the second device transmission 1010. The first device 102 can receive information in the first communication unit 1016 from the second device transmission 1010 of the communication path 104. The content delivery system 100 can be executed by the first control unit 1012, the second control unit 1034, or a combination thereof. For illustrative purposes, the second device 106 is shown with the partition having the second user interface 1038, the second storage unit 1046, the second control unit 1034, and the second communication unit 1036, although it is understood that the second device 106 can have a different partition. For example, the second software 1042 can be partitioned differently such that some or all of its function can be in the second control unit 1034 and the second communication unit 1036. Also, the second device 106 can include other functional units not shown in FIG. 10 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the content delivery system 100 is described by operation of the first device 102 and the second device 106. It is understood that the first device 102 and the second device 106 can operate any of the modules and functions of the content delivery system 100. For example, the first device 102 is described to operate the location unit 1020, although it is understood that the second device 102 can also operate the location unit 1020.

A first capturing sensor 1052 can be the capturing sensor 208 of FIG. 2. The first capturing sensor 1052 can capture the situation 314 of FIG. 3 occurring in the venue 204 of FIG. 2. Examples of the first capturing sensor 1052 can include a digital camera, video camera, thermal camera, night vision camera, infrared camera, x-ray camera, or the combination thereof. Examples of the first capturing sensor 1052 can include accelerometer, thermometer, microphone, wireless signal receiver, remote physiological monitoring device, light identifier, or the combination thereof.

A second capturing sensor 1054 can be the capturing sensor 208. The second capturing sensor 1054 can capture the situation 314 occurring in the venue 204. Examples of the second capturing sensor 1054 can include a digital camera, video camera, thermal camera, night vision camera, infrared camera, x-ray camera, or the combination thereof. Examples of the second capturing sensor 1054 can include accelerometer, thermometer, microphone, wireless signal receiver, remote physiological monitoring device, light identifier, or the combination thereof.

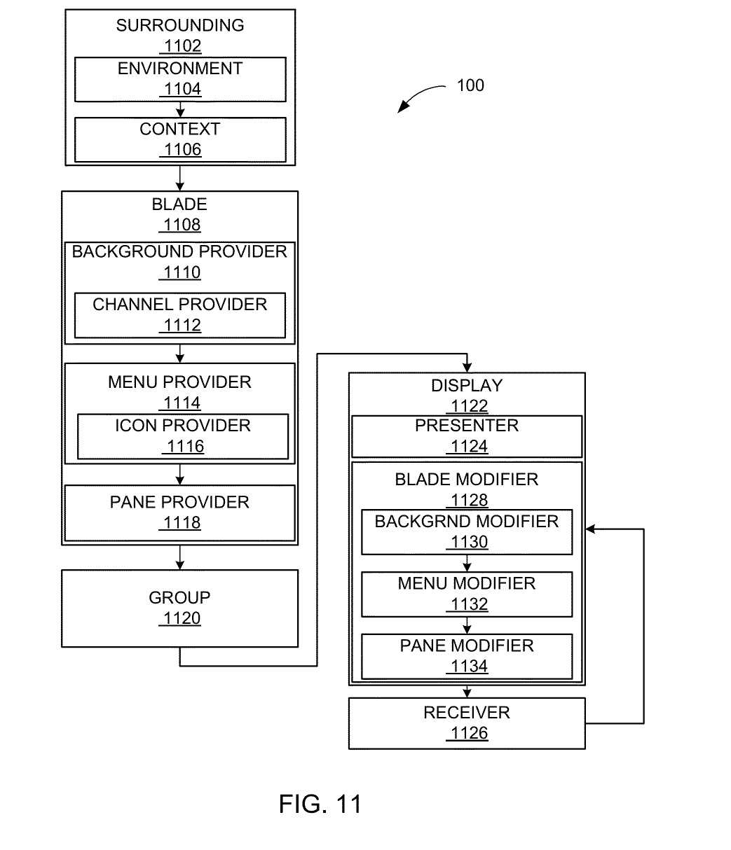

Referring now to FIG. 11 therein is shown a control flow of the content delivery system 100. The content delivery system 100 can include a surrounding module 1102. The surrounding module 1102 determines the context 616 of FIG. 6. For example, the surrounding module 1102 can determine the context 616 based on identifying the environmental condition 618 of FIG. 6 of where the first device 102 of FIG. 1 is situated.

The surrounding module 1102 can include an environment module 1104. The environment module 1104 identifies the environmental condition 618. For example, the environment module 1104 can identify the environmental condition 618 based on the current location 620 of FIG. 6, the other user's location 622 of FIG. 6, the time information 602 of FIG. 6, or a combination thereof.

The environment module 1104 can identify the environmental condition 618 in a number of ways. For example, the environment module 1104 can identify the environmental condition 618 representing the private environment 624 of FIG. 6. The environment module 1104 can identify the private environment 624 based on locating the current location 620 to be at user's home via the location unit 1020 of FIG. 10. For another example, the environment module 1104 can identify the private environment 624 based on locating the other user's location 622 to be outside of the user's home via receiving the location information for the other user via the first control interface 1022 of FIG. 10. For further example, the environment module 1104 can identify the private environment 624 based on the identifying the time information 602 representing 9 PM in the evening in addition to the current location 620 to be at the user's home.

For a different example, the environment module 1104 can identify the environmental condition 618 representing the public environment 626 of FIG. 6. The environment module 1104 can identify the public environment 626 based on locating the current location 620 to be at user's work office via the location unit 1020. For another example, the environment module 1104 can identify the public environment 626 based on locating the other user's location 622 to be in the same location as the current location 620 via the first control interface 1022 of FIG. 10. For further example, the environment module 1104 can identify the public environment 626 based on identifying the time information 602 to be 2 PM in the afternoon in addition to the current location 620 to be at the user's office. The environment module 1104 can send the environmental condition 618 to a context module 1106.

The surrounding module 1102 can include the context module 1106, which can couple to the environment module 1104. The context module 1106 determines the context 616. For example, the context module 1106 can determine the context 616 based on the environmental condition 618 identified.

The context module 1106 can determine the context 616 in a number of ways. For example, the context module 1106 can determine the context 616 based on the private environment 624. More specifically, by identifying the private environment 624, the context module 1106 can determine the context 616 where the user with the first device 102 is situated to be low at risk for other user to be able to view the display interface 204 of FIG. 2. In contrast, by identifying the public environment 626, the context module 1106 can determine the context 616 where the user with the first device 102 is situated to be high at risk for the other user to be able to view the display interface 204. The context module 1106 can send the context 616 determined to a blade module 1108.

The content delivery system 100 can include the blade module 1108, which can couple to the surrounding module 1102. The blade module 1108 provides the blade interface 202 of FIG. 2. For example, the blade module 1108 can provide the blade interface 202 based on the interface type 206 of FIG. 2 representing the background interface 208 of FIG. 2, the menu interface 212 of FIG. 2, the pane interface 218 of FIG. 2, or a combination thereof.

The blade module 1108 can provide the blade interface 202 in a number of ways. The blade module 1108 can include a background provider module 1110. The background provider module 1110 provides the background interface 208. For example, the background provider module 1110 can provide the background interface 208 based on the content type 230 of FIG. 2, the user type 630 of FIG. 6, the context 616, the privacy setting 628 of FIG. 6, or a combination thereof.

The background provider module 1110 can provide the background interface 208 in a number of ways. For example, the background provider module 1110 can provide the background interface 208 based on the content type 230, the user type 630, or a combination thereof. More specifically, the user type 630 can represent the user of the first device 102 with administrator privileges. The content type 230 can include the feature icon 232 of FIG. 2 representing the application icon 236 of FIG. 2. The application icon 236 can include the setting icon to change the privilege to access the first device 102. Based on the user type 630, the background provider module 1110 can provide the background interface 208 having the application icon 236 of setting icon. In contrast, the user type 630 can represent a guest without any administrator privileges. The background provider module 1110 can provide the background interface 208 without the application icon 236 of setting icon based on the user type 630.

For a different example, the background provider module 1110 can provide the background interface 208 based on the content type 230, the context 616, the privacy setting 628, or a combination thereof. The context 616 can represent the user working at the office in the public environment 626. The privacy setting 628 can be set to disclose the content type 230 with the category of interest 608 representing work. The background provider module 1110 can provide the background interface 208 having the content type 230 of the application icon 236 related to work and not including the application icon 236 unrelated to work based on the content type 230, the context 616, and the privacy setting 628.

For a different example, the background provider module 1110 can provide the background interface 208 based on the content type 230, such as the profile information 606 of FIG. 6, the communication information 234 of FIG. 2., or a combination thereof. The content type 230 can represent the communication information 234. The profile information 606 can disclose that the user of the first device 102 can represent a married woman in her thirties with two children. The background provider module 1110 can provide the background interface 208 with the communication information 234 representing a communication record, such as missed calls, new messages, new emails, comments exchanged, or a combination thereof from her husband based on the profile information 606.

The background provider module 1110 can include a channel provider module 1112. The channel provider module 1112 provides the channel interface 302 of FIG. 3. For example, the channel provider module 1112 can provide the channel interface 302 based on the content type 230.

The channel provider module 1112 can provide the channel interface 302 in a number of ways. For example, the content type 230 can represent the communication information 234. As discussed above, the communication information 234 can include the communication record, such as missed calls, new messages, new emails, comments exchanged, or a combination thereof. The channel provider module 1112 can provide the channel interface 302 for each type of the communication information 234. More specifically, the channel provider module 1112 can provide the channel interface 302 for the communication information 234 representing the communication record of missed calls. The channel provider module 1112 can provide a separate instance of the channel interface 302 for the communication information 234 representing the communication record of text messages. The background provider module 1110 can send the background interface 208, the channel interface 302, or a combination thereof to a menu provider module 1114.

The blade module 1108 can include the menu provider module 1114, which can couple to the background provider module 1110. The menu provider module 1114 provides the menu interface 212. For example, the menu provider module 1114 can provide the menu interface 212 based on the menu type 402 of FIG. 4, the content type 230, the user type 630, the profile information 606, the context 616, the privacy setting 628, or a combination thereof.

The menu provider module 1114 can provide the menu interface 212 in a number of ways. For example, the menu provider module 1114 can provide the menu interface 212 based on the content type 230. More specifically, the content type 230 can represent the entertainment information 612 of FIG. 6 for music. The menu provider module 1114 can provide the menu interface 212 having the feature icon 232 representing the tool icon 414 of FIG. 4. The tool icon 414 can represent the audio control, such as play, fast forward, rewind, change volume, or a combination thereof.

For a different example, the menu provider module 1114 can provide the menu interface 212 based on the menu type 402. For example, the menu provider module 1114 can provide the menu type 402 representing the headline menu 404 of FIG. 4 to display the tool icon 414 most frequently used. For a different example, the menu provider module 1114 can provide the feature menu 410 of FIG. 4 to display all instances of the tool icon 414 installed within the first device 102. For another example, the menu provider module 1114 can provide the indicator menu 418 of FIG. 4 to display the icon indicator 420 of FIG. 4.

The menu provider module 1114 can include an icon provider module 1116. The icon provider module 1116 provides the feature icon 232. For example, the icon provider module 1116 can provide the feature icon 232 based on the activity record 406 of FIG. 4, the icon priority 408 of FIG. 4, or a combination thereof.

The icon provider module 1116 can provide the feature icon 232 in a number of ways. For example, the icon provider module 1116 can provide the tool icon 414 having the icon dimension 422 of FIG. 4 based on the activity record 406. More specifically, the activity record 406 can indicate the tool icon 414 most frequently used. The icon provider module 1116 can provide the tool icon 414 having the largest size of the icon dimension 422 for the tool icon 414 most frequently used. The icon provider module 1116 can provide the tool icon 414 having the smallest size of the icon dimension 422 for the tool icon 414 least frequently used.

For another example, the icon provider module 1116 can provide the application icon 236 having the icon dimension 422 based on the icon priority 408. More specifically, the icon provider module 1116 can provide the application icon 236 having the largest size of the icon dimension 422 for the application icon 236 having the highest priority of the icon priority 408. The icon provider module 1116 can provide the application icon 236 having the smallest size of the icon dimension 422 for the application icon 236 having the lowest priority of the icon priority 408.

It has been discovered that the content delivery system 100 can improve the usability of the first device 102 by changing the icon dimension 422 of the feature icon 232 based on the activity record 406, the icon priority 408, or a combination thereof. By increasing the size of the icon dimension 422 based on the activity record 406, the icon priority 408, or a combination thereof, the content delivery system 100 can improve the visibility of the feature icon 232 available for the user to select. As a result, the user can select the feature icon 232 from the menu interface 212 more efficiently for improving the user experience of the content delivery system 100, the first device 102, or a combination thereof.

For further example, the icon provider module 1116 can provide the feature icon 232 within the tool interface 412 of FIG. 4 of the menu interface 212. For example, the menu interface 212 can include four instances of the tool interface 412 with the descending size of the tool menu dimension 416 of FIG. 4, from left to right or vice versa. More specifically, the tool interface 412 having the largest size of the tool menu dimension 416 can be provided on the most left-hand side of the menu interface 212 viewing the display interface 204. And the tool interface 412 having the smallest size of the tool menu dimension 416 can be provided on the most right-hand side of the menu interface 212 viewing the display interface 204. The icon provider module 1116 can provide a plurality of the feature icon 232, such as the tool icon 414, having the icon dimension 422 that fit within the tool interface 412. More specifically, the tool icon 414 having the largest size of the icon dimension 422 can be provided within the tool interface 412 having the largest size of the tool menu dimension 416.

For a different example, the icon provider module 1116 can provide the icon indicator 420 based on the content type 230, the icon priority 408, the activity record 406, or a combination thereof. The icon provider module 1116 can provide the icon indicator 420 for the tool icon 414 having the highest priority of the icon priority 408. The icon provider module 1116 can provide the icon indicator 420 for the tool icon 414 based on the activity record 406 representing the most frequently used. For further example, the icon provider module 1116 can provide the icon indicator 420 on the indicator menu 418 based on the content type 230 currently displayed on the blade interface 202, such as the background interface 208, the pane interface 218, or a combination thereof. The menu provider module 1114 can send the menu interface 212 to a pane provider module 1118.

It has been discovered that the content delivery system 100 can improve the usability of the first device 102 by providing the icon indicator 420 based on the content type 230, the activity record 406, the icon priority 408, or a combination thereof. By providing the icon indicator 420 based on the content type 230, the activity record 406, the icon priority 408, or a combination thereof, the content delivery system 100 can improve the visibility of the tool icon 414 available for the user to select. As a result, the user can select the icon indicator 420 from the indicator menu 418 for accessing the tool icon 414 more efficiently for improving the user experience of operating the content delivery system 100, the first device 102, or a combination thereof.

The blade module 1108 can include the pane provider module 1118, which can couple to the menu provider module 1114. The pane provider module 1118 provides the pane interface 218. For example, the pane provider module 1118 can provide the pane interface 218 based on the content type 230, the user type 630, the profile information 606, the context 616, the privacy setting 628, or a combination thereof.

The pane provider module 1118 can provide the pane interface 218 in a number of ways. For example, the pane provider module 1118 can provide the pane interface 218 having a plurality of the content type 230. More specifically, the plurality of the content type 230 can include a digital photograph of the entertainment information 612, a title of the entertainment information 612, and a synopsis of entertainment information 612. The pane provider module 1118 can provide the plurality of the content type 230 within the single instance of the pane interface 218.

For further example, the pane provider module 1118 can provide the content type 230 based on the side non-right angle 228 of FIG. 2 of the non-horizontal slant side 222 of FIG. 2. More specifically, the pane provider module 1118 can adjust the display of the content to align with the side non-right angle 228. For example, the content can initially be displayed at perpendicular to the top extent and the bottom extent of the display interface 204. If the side non-right angle 228 is at 70 degrees, the pane provider module 118 can adjust the content to be displayed at 70 degrees on the pane interface 218.

For a different example, the pane provider module 1118 can provide a plurality of the subpane interface 514 of FIG. 5 within the pane interface 218. More specifically, the pane provider module 1118 can provide the subpane interface 514 having each instance of the content type 230 to be displayed. Continuing with the previous example, one instance of the subpane interface 514 can have the content type 230 representing the digital photograph of the entertainment information 612. Another instance of the subpane interface 514 can have the content type 230 of the title of the entertainment information 612. And a different instance of the subpane interface 514 can have the content type 230 of the synopsis of the entertainment information 612. The pane provider module 1118 can provide the pane interface 218 with the one instance of the subpane interface 514 overlaid on top of another instance of the subpane interface 514.

For a different example, the pane provider module 1118 can provide the pane indicator 710 of FIG. 7. More specifically, the pane provider module 1118 can provide the pane indicator 710 to represent the minimized instance of pane interface 218. The pane provider module 1118 can send the pane interface 218 to a group module 1120.

The content delivery system 100 can include the group module 1120, which can couple to the blade module 1108. The group module 1120 generates the interface group 702 of FIG. 7. For example, the group module 1120 can generate the interface group 702 based on grouping the blade interface 202.

The group module 1120 can generate the interface group 702 in a number of ways. For example, the group module 1120 can generate the interface group 702 based on grouping the blade interface 202 according to the content type 230, the category of interest 608, the profile information 606, the user type 630, the context 616, the privacy setting 628, or a combination thereof.

For a specific example, the group module 1120 can generate the interface group 702 based on grouping the blade interface 202 according the content type 230, the category of interest 608, or a combination thereof. More specifically, the group module 1120 can generate the interface group 702 based on grouping the background interface 208, the menu interface 212, the pane interface 218, or a combination thereof providing the content type 230 categorized according to the category of interest 608.

For further example, the category of interest 608 can represent Italian food. The background interface 208 can provide the content type 230 representing the time information 602 related to the calendar information for when the user of the first device 102 plans to visit the restaurant for Italian food. The menu interface 212 can provide the content type 230 for the application icon 236, such as Yelp!™, an American directory and rating website, for accessing information regarding the restaurant. The pane interface 218 can provide the content type 230 representing the profile information 606 of people who are scheduled to attend the restaurant with the user. Another instance of the pane interface 218 can provide the content type 230 representing the navigation information 604 of FIG. 6 for reaching the restaurant. The group module 1120 can generate the interface group 702 for the Italian restaurant, the interface group 702 including a plurality of the blade interface 202 providing the content type 230 for when the user and with whom the user plans to attend the restaurant, directions to reach the restaurant, and reviews regarding the restaurant.

For a different example, the group module 1120 can generate the interface group 702 based on grouping the background interface 208, the menu interface 212, the pane interface 218, or a combination thereof permitted to be grouped according to the privacy setting 628 for the user type 630. The user type 630 can represent the user of the first device 102 having administrative privileges. The privacy setting 628 can be set to allow the group module 1120 to generate the interface group 702 to group the background interface 208, the menu interface 212, the pane interface 218, or a combination thereof without any restriction for the user type 630 with administrative privileges.

In contrast, if the user type 630 represents a guest, the privacy setting 628 can be set to restrict the grouping of the blade interface 202. More specifically, the privacy setting 628 can be set so that the group module 1120 can prohibit the grouping of the menu interface 212 providing the tool icon 414 for sending email with the pane interface 218 providing the profile information 606 for the user type 630 of guest.

For a different example, the group module 1120 can generate the interface group 702 based on grouping a plurality of the pane interface 218 sharing the genre type 614 of FIG. 6. For example, the genre type 614 can represent “Rock Music.” The group module 1120 can generate the interface group 702 based on grouping the plurality of the pane interface 218 having the entertainment information 612 sharing the genre type 614 of “Rock Music.”

For another example, the group module 1120 can generate the interface group 702 based on the interface relationship 704 of FIG. 7. As discussed above, the interface relationship 704 can represent the association between the parent interface 706 of FIG. 7 and the child interface 708 of FIG. 7. The group module 1120 can generate the interface group 702 by grouping the background interface 208, the menu interface 212, the pane interface 218, or a combination thereof according to the interface relationship 704.

For a specific example, the background interface 208 can represent the parent interface 706 providing the communication information 234. The group module 1120 can generate the interface group 702 by grouping the pane interface 218 representing the child interface 708 having the interface relationship 704 with the parent interface 706. More specifically, the interface relationship 704 can define that a plurality of the child interface 708 can have the interface relationship 704 with the parent interface 706.

Continuing with the example, the interface relationship 704 can define that the child interface 708 providing the social media information 610 of FIG. 6 and the child interface 708 providing the entertainment information 612 representing music can have the interface relationship 704 with the parent interface 706 providing the content type 230 of the communication information 234. As a result, the group module 1120 can generate the interface group 702 including the background interface 208 providing the communication information 234 with the plurality of the pane interface 218 providing the social media information 610, the entertainment information 612, or a combination thereof based on the interface relationship 704.

For further example, the group module 1120 can generate the interface group 702 by grouping a plurality of the blade interface 202 sharing the interface relationship 704 signified by the same coloration. More specifically, the group module 1120 can generate the interface group 702 by grouping the parent interface 706 and the child interface 708 sharing the color orange but excluding the blade interface 202 in different color.

It has been discovered that the content delivery system 100 can improve the usability of the first device 102 by generating the interface group 702 by grouping a plurality of the blade interface 202 having the interface relationship 704 with each other. By having the interface group 702 organized according to the interface relationship 704, the user can efficiently select one instance of the blade interface 202 to another instance of the blade interface 202 that is related. As a result, the user's ability to efficiently select the blade interface 202 improves the user experience of operating the content delivery system 100, the first device 102, or a combination thereof.

For further example, the group module 1120 can generate the interface group 702 by grouping a plurality of the blade interface 202 having the same angle of the side non-right angle 228 of FIG. 2. For example, the side non-right angle 228 for the non-horizontal slant side 222 of the pane interface 218 can represent 75 degrees relative to the top extent of the display interface 204. The group module 1120 can generate the interface group 702 by grouping the plurality of the pane interface 218 with the content type 230 of the social media information 610 if the pane interface 218 has the side non-right angle 228 of 75 degrees. The group module 1120 can generate the interface group 702 by grouping the plurality of the pane interface 218 with the content type 230 of the entertainment information 612 for the pane interface 218 having the side non-right angle of 65 degrees.

It has been discovered that the content delivery system 100 can improve the usability of the first device 102 by generating the interface group 702 based on the plurality of the blade interface 202 having the same angle of the side non-right angle 228. Generating the interface group 702 based on the side non-right angle 228 improves the ability of the user to identify the related instances of the blade interface 202. As a result, the user's ability to efficiently select the blade interface 202 having the same visual cue improves the user experience of operating the content delivery system 100, the first device 102, or a combination thereof.

For another example, the group module 1120 can generate the interface group 702 based on organizing a plurality of the blade interface 202 according to the stack mode 902 of FIG. 9, the expand mode 904 of FIG. 9, or a combination thereof. The group module 1120 can generate the interface group 702 according to the stack mode 902, the expand mode 904, or a combination thereof based on the content type 230, the user type 630, the profile information 606, the context 616, the privacy setting 628, or a combination thereof. For a specific example, the group module 1120 can generate the interface group 702 by grouping a plurality of the pane interface 218 according to the content type 230. More specifically, the interface group 702 can include each instances of the pane interface 218 representing the entertainment information 612, the category of interest 608, the social media information 610, the navigation information 604, or a combination thereof. The group module 1120 can send the interface group 702 to a display module 1122.

The content delivery system 100 can include the display module 1122, which can couple to the group module 1120. The display module 1122 displays the blade interface 202. For example, the display module 1122 can display the blade interface 202 based on the display rule 510 of FIG. 5, the interface group 702, or a combination thereof. For another example, the display module 1122 can display the blade interface 202 based on the content type 230, the user type 630, the profile information 606, the context 616, the privacy setting 628, or a combination thereof.

The display module 1122 can display the blade interface 202 in a number of ways. The display module 1122 can include a presenter module 1124. The presenter module 1124 displays the blade interface 202. For example, the presenter module 1124 can display the blade interface 202 based on the display rule 510, the interface group 702, or a combination thereof. For another example, the presenter module 1124 can present the blade interface 202 based on the content type 230, the user type 630, the profile information 606, the context 616, the privacy setting 628, or a combination thereof.

The presenter module 1124 can display the blade interface 202 in a number of ways. The presenter module 1124 can display the blade interface 202 according to the display rule 510 based on the activity record 406. More specifically, the display rule 510 can represent the constraint to factor the activity record 406 representing the frequency of usage for displaying the blade interface 202 on the display interface 204. For example, the presenter module 1124 can display the feature icon 232 representing the application icon 236 in an order with the activity record 406 of most frequently used within the headline menu 404 of the menu interface 212. For further example, the presenter module 1124 can display all instances of the application icon 236 regardless of the activity record 406 under the headline menu 404 within the feature menu 410 of the menu interface 212.

For another example, the presenter module 1124 can display a plurality of the pane interface 218 based on the activity record 406 for most frequently selected instance of the pane interface 218. The presenter module 1124 can display the pane interface 218 most frequently selected on the left most side of the display interface 204. The presenter module 1124 can display the pane interface 218 in an order from most frequently selected to less frequently selected from left to right of the display interface 204. The pane interface 218 least frequently selected amongst the instances of the pane interface 218 displayed can be displayed on the right most side of the display interface 204.

For another example, the presenter module 1124 can display a plurality of the pane indicator 710 based on the activity record 406 representing the timing of the selection of the pane interface 218. More specifically, the first instance of the pane indicator 710 can be displayed on the bottom right corner of the display interface 204. The presenter module 1124 can display a second instance of the pane indicator 710 displayed adjacent to the first instance of the pane indicator 710. Moreover, the second instance of the pane indicator 710 can contact the bottom extent and the side extent of the display interface 204 along with contacting the first instance of the pane indicator 710. The presenter module 1124 can display the first instance of the pane indicator 710 at the bottom right corner of the display interface 204 based on the activity record 406 representing the selection of the pane interface 218 at an earlier time than the pane interface 218 for the second instance of the pane indicator 710. The timing of the selection of the pane interface 218 can be indicated by from left to right where the left instance of the pane indicator 710 representing that the pane interface 218 that has been selected more recently.

It has been discovered that the content delivery system 100 can improve the usability of the first device 102 by displaying the blade interface 202 based on the activity record 406. By displaying the blade interface 202 according to the activity record 406 representing, for example, the most frequent usage, the user can view the blade interface 202 that is most relevant to the user. As a result, the efficient presentation of the blade interface 202 improves the user experience for operating the content delivery system 100, the first device 102, or a combination thereof.

For a different example, the presenter module 1124 can display the blade interface 202 based on the display rule 510. The display interface 204 can be displayed as the vertical display orientation 502 of FIG. 5 or the horizontal display orientation 504 of FIG. 5. Based on the display rule 510, if the display interface 204 is displayed as the vertical display orientation 502, the presenter module 1124 can display the blade interface 202 in the vertical display orientation 502. For example, the presenter module 1124 can display the pane interface 218 in the vertical display orientation 502 based on the display rule 510. More specifically, a width of the top extent, the bottom extent, or a combination thereof of the pane interface 218 can be less than 50% in distance than a height of the non-horizontal slant side 222 of the pane interface 218 when the pane interface 218 is displayed in the vertical display orientation 218.

In contrast, based on the display rule 510, if the display interface 204 is displayed as the horizontal display orientation 504, the presenter module 1124 can display the blade interface 202 in the horizontal display orientation 504. For example, the presenter module 1124 can display the pane interface 218 in the horizontal display orientation 504 based on the display rule 510. More specifically, a width of the top extent, the bottom extent, or a combination thereof of the pane interface 218 can be greater than 50% in distance than the height of the non-horizontal slant side 222 of the pane interface 218. For further example, a width of the top extent, the bottom extent, or a combination thereof of the pane interface 218 can be greater in distance than the height of the non-horizontal slant side 222 of the pane interface 218.

For another example, the presenter module 1124 can display the pane interface 218 without a plurality of the subpane interface 514 if the display interface 204 is displayed in the vertical display orientation 502. In contrast, the presenter module 1124 can display the pane interface 218 segmented by a plurality of the subpane interface 514 if the display interface 204 is displayed in the horizontal display orientation 504.

It has been discovered that the content delivery system 100 can improve the usability of the first device 102 by displaying the blade interface 202 according to the display rule 510. By displaying the blade interface 202 according to the display rule 510, the content delivery system 100 can customize the presentation of the blade interface 202 to improve the visibility of the content presented on the blade interface 202. As a result, the improvement of the visibility of the blade interface 202 improves the user experience for operating the content delivery system 100, the first device 102, or a combination thereof.

For another example, the presenter module 1124 can display the pane interface 218 with the content type 230 of text. More specifically, the text can be italicized. The side non-right angle 228 of the non-horizontal slant side 222 of the pane interface 218 can represent 75 degrees. The presenter module 1124 can display the pane interface 218 with the angle of the italic of the text to be parallel with the side non-right angle 228 of the non-horizontal slant side 222.

For a different example, the presenter module 1124 can display the blade interface 202 based on the interface group 702. The presenter module 1124 can display the blade interface 202 based on the interface group 702 in a number of ways. For example, the interface group 702 can represent a single instance of the interface type 206. Based on the interface group 702, the presenter module 1124 can display the background interface 208 on the display interface 204 without the menu interface 212 or the pane interface 218. The presenter module 1124 can also display the menu interface 212 on the display interface 204 without the background interface 208 or the pane interface 218. The presenter module 1124 can also display the pane interface 218 on the display interface 204 without the background interface 208 or the menu interface 212.

For another example, the interface group 702 can represent the combination of a plurality of the interface type 206. More specifically, the presenter module 1124 can display the menu interface 212 and the pane interface 218 overlapping the background interface 208 based on the interface group 702. More specifically, according to the interface group 702, the menu interface 212 can overlap the pane interface 218 and the background interface 208 with a portion of the pane interface 218 and a portion of the background interface 208 uncovered by the menu interface 212. Furthermore, the menu interface 212, the pane interface 218, the background interface 208, or a combination thereof can overlap one another creating the blade non-right angle 226 of FIG. 2.

Furthermore, the presenter module 1124 can display a plurality of the pane interface 218 on the display interface 204 based on the interface group 702. More specifically, according to the interface group 702, an instance of the pane interface 218 can overlap another instance of the pane interface 218 adjacently to the right, to the left, or a combination thereof as illustrated in FIG. 2 along the non-horizontal slant side 222 of the pane interface 218. The overlapped instance of the pane interface 218 can have a portion of the pane interface 218 uncovered, thus, still displaying the content type 230. For another example, the presenter module 1124 can display the plurality of the pane interface 218 with the non-horizontal slant side 222 contiguously connected to the non-horizontal slant side 222 of the adjacent instance of the pane interface 218.

For example, the interface group 702 can represent a plurality of the blade interface 202 based on the interface type 206. More specifically, according to the interface group 702, the presenter module 1124 can display a plurality of the blade interface 202 grouped with a plurality of the interface type 206. For example, the interface group 702 can be generated based on the plurality of the blade interface 202 sharing the same instance of the content type 230. The content type 230 can represent the communication information 234. The presenter module 1124 can display the menu interface 212 and the pane interface 218 that share the content type 230 of the communication information 234 based on the interface group 702.

For a different example, the presenter module 1124 can display the pane interface 218 based on the content priority 632 of FIG. 6. The content priority 632 can represent a constraint on the presenter module 1124 to display the pane interface 218 on the display interface 204. For example, the content priority 632 can be based on the content type 230, the activity record 406, or a combination thereof.

More specifically, the presenter module 1124 can display the pane interface 218 having the content type 230 with the highest of the content priority 632 closest to the top extent of the display interface 204. The lower the content priority 632 of the content type 230 is, the closer to the bottom extent of the display interface 204 that the presenter module 1124 can display the pane interface 218.

For another example, the presenter module 1124 can display the pane interface 218 having the content type 230 with the highest of the content priority 632 with the highest number of the side number 634 of FIG. 6 for the pane interface 218. More specifically, the pane interface 218 having the lowest of the content priority 632 can have the lowest number of the side number 634 representing three. The pane interface 218 having the content type 230 with the higher of the content priority 632 can have the side number 634 greater than 3.

For a different example, the presenter module 1124 can display the pane interface 218 with the pane dimension 220 greater in the surface area size than another instance of the pane interface 218 having the content type 230 with lower of the content priority 632. Further, the pane dimension 220 can differ in the surface area size based on the privacy setting 628, the context 616, or a combination thereof. The privacy setting 628 can indicate the presenter module 1124 can change the pane dimension 220 of the pane interface 218 to be displayed based on the context 616. More specifically, if the context 616 is determined to be in the public environment 626, the presenter module 1124 can display the pane interface 218 with smaller surface size for the pane dimension 220 than the context determined to be in the private environment 624.

It has been discovered that the content delivery system 100 can improve the usability of the first device 102 by displaying the blade interface 202 based on the content priority 632, the privacy setting, the context 616, or a combination thereof. By adjusting the blade dimension 210 according to the content priority 632, the privacy setting, the context 616, or a combination thereof, the content delivery system 100 can customize the presentation of the blade interface 202 to improve the visibility of the content presented on the blade interface 202. As a result, the improvement of the visibility of the blade interface 202 improves the user experience for operating the content delivery system 100, the first device 102, or a combination thereof.

The content delivery system 100 can include a receiver module 1126, which can couple to the display module 1122. The receiver module 1126 receives the gesture type 802 of FIG. 8. For example, the receiver module 1126 can receive the gesture type 802 representing the pinching gesture for modifying the blade dimension 210 of FIG. 2 by the user contacting the display interface 204. More specifically, the receiver module 1126 can receive the gesture type 802 on the blade interface 202, such as the background interface 208, the menu interface 212, the pane interface 218, or a combination thereof. The receiver module 1126 can send the gesture type 802 received to the to the display module 1122.

For illustrative purposes, the content delivery system 100 is shown with the display module 1122 displaying the blade interface 202, although it is understood the display module 1122 can be operated differently. For example, the display module 1122 can modify the blade dimension 210 of the blade interface 202 based on the gesture type 802.

The display module 1122 can modify the blade dimension 210 in a number of ways. The display module 1122 can include a blade modifier module 1128. The blade modifier module 1128 modifies the blade dimension 210. For example, the blade modifier module 1128 can modify the blade dimension 210 based on the gesture type 802 for displaying the blade interface 202 modified on the display interface 204.

The blade modifier module 1128 can include a background modifier module 1130. The background modifier module 1130 modifies the displaying of the background interface 208. For example, the background modifier module 1130 can modify the background interface 208 based on the gesture type 802 of the tap gesture. More specifically, the background interface 208 can have the content type 230 of the communication information 234. Upon receiving the gesture type 802 of the tap gesture on the communication information 234 displayed on the background interface 208, the background modifier module 1130 can modify the background interface 208 to display the channel interface 302. The tap gesture can select the “missed call” for the communication information 234 on the background interface 208. The background modifier module 1130 can display the channel interface 302 for the “missed call” upon receiving the tap gesture.

The blade modifier module 1128 can include a menu modifier module 1132. The menu modifier module 1132 modifies the menu interface 212. For example, the menu modifier module 1132 can modify the menu dimension 214 of FIG. 2 of the menu interface 212 based on receiving the gesture type 802 of the dragging gesture.

The menu modifier module 1132 can modify the menu interface 212 in a number of ways. For example, the user can select the slant menu side 216 of FIG. 2 at the top extent of the menu interface 212 and drag the menu interface 212 towards the top extent of the display interface 204. Based on the extent of the dragging gesture, the menu interface 212 can be extended to cover the display interface 204 in its entirety. In a different scenario, the dragging gesture can drag the menu interface 212 to cover a portion of the display interface 204, the background interface 208, the pane interface 218, or a combination thereof. For further example, the dragging gesture can drag the menu interface 212 to expose the headline menu 404 in its entirety and disclose a portion of the feature menu 410. For another example, the dragging gesture can drag the menu interface 212 to cover or expose the indicator menu 418.

It has been discovered that the content delivery system 100 can improve the usability of the first device 102 by allowing the user to control the amount of the background interface 208, the pane interface 218, or a combination thereof covered after receiving the gesture type 802 of the dragging gesture. By providing granular control to cover or uncover the blade interface 202, the user can customize the blade interface 202 visible on the display interface 204. As a result, the improvement of the visibility of the blade interface 202 improves the user experience for operating the content delivery system 100, the first device 102, or a combination thereof.

For another example, the menu modifier module 1132 can modify the menu interface 212 based on the gesture type 802, the display rule 510, or a combination thereof. The display rule 510 can indicate that the interface type 206 to be displayed can base on the directionality of the gesture type 802 representing the pull gesture. For example, the display rule 510 can represent the pull gesture from the bottom extent towards the top extent of the display interface 204 can represent the displaying of the menu interface 212.

For another example, the menu modifier module 1132 can modify the menu interface 212 based on the receiving the gesture type 802 of the tap gesture. More specifically, the indicator menu 418 can display the icon indicator 420. The icon indicator 420 representing the tool icon 414 with the highest priority of the icon priority 408 amongst the instances of the tool icon 414 within the menu interface 212. Based on the tap gesture on the icon indicator 420, the menu modifier module 1132 can modify the indicator menu 418 to display the menu interface 212 to display all instances of the tool icon 414 within the menu interface 212.

For another example, the menu modifier module 1132 can modify the menu interface 212 based on receiving the gesture type 802 of the fling gesture. More specifically, based on the fling gesture, the menu modifier module 1132 can modify the menu interface 212 by allowing the user to scroll the tool icon 414 displayed on the menu interface 212. Furthermore, as discussed below, the scroll direction 804 of FIG. 8 of the menu interface 212 can be the same direction as the scroll direction 804 for scrolling a plurality of the pane interface 218 or the different direction as the scroll direction 804 for scrolling the plurality of the pane interface 218. For a specific example, the scroll direction 804 of the menu interface 212 can be right while the scroll direction 804 of the pane interface 218 can be left.

It has been discovered that the content delivery system 100 can improve the usability of the first device 102 by providing granular control for the directionality of the scroll direction 804 for scrolling a plurality of the blade interface 202. By allowing different instances of the scroll direction 804 for multiple instances of the blade interface 202 allows the user to better control the interface type 206 that the user would like to view. As a result, the improvement of the visibility of the blade interface 202 improves the user experience for operating the content delivery system 100, the first device 102, or a combination thereof.

The blade modifier module 1128 can include a pane modifier module 1134. The pane modifier module 1134 modifies the pane interface 218. For example, the pane modifier module 1134 can modify the pane dimension 220 of FIG. 2 of the pane interface 218 based on the gesture type 802 received.

The pane modifier module 1134 can modify the pane interface 218 in a number of ways. For example, as discussed above, the user can scroll the pane interface 218 based on the gesture type 802 of the fling gesture. For another example, the pane modifier module 1134 can modify the pane interface 218 based on the gesture type 802 representing the dragging gesture by dragging down the top slant pane side 224 of FIG. 2 towards the bottom extent of the display interface 204 to expose the background interface 208 while the menu interface 212 overlaps the pane interface 218.

It has been discovered that the content delivery system 100 can improve the usability of the first device 102 by allowing instances of the blade interface 202 to overlap each other. By providing flexibility for the user to cover or uncover the blade interface 202, the user can better control the blade interface 202 and the content type 230 that user desires to view. As a result, the improvement of the visibility of the blade interface 202 improves the user experience for operating the content delivery system 100, the first device 102, or a combination thereof.

For another example, the pane modifier module 1134 can modify the pane interface 218 based on the gesture type 802 of the press gesture. The user can select the pane interface 218 with the press gesture. Based on the press gesture, the pane modifier module 1134 can change the pane dimension 220 for providing the content preview 806 of FIG. 8. More specifically, the press gesture can change the pane dimension 220 by increasing the distance between the side extents of the pane interface 218 to increase the surface area of the pane interface 218. For a different example, the press gesture can change the pane dimension 220 by changing the side number 634 of the pane interface 218. As an example, the pane modifier module 1134 can provide the content preview 806 by increasing the side number 634 from three sides to four sides. More specifically, the content preview 806 for the pane interface 218 can overlap the another instance of the pane interface 218 unmodified by the gesture type 802.

It has been discovered that the content delivery system 100 can improve the usability of the first device 102 by changing the pane dimension 220 of the pane interface 218 for displaying the content preview 806. By increasing the side number 634 of the pane interface 218, the content delivery system 100 can increase the pane dimension 220 to improve the visibility of the content displayed on the pane interface 218. As a result, the improvement of the visibility of the blade interface 202 improves the user experience for operating the content delivery system 100, the first device 102, or a combination thereof.

For another example, the pane modifier module 1134 can modify a plurality of the pane interface 218 arranged in the stack mode 902. Based on the downward shake gesture, the pane modifier module 1134 can modify the plurality of the pane interface 218 in the stack mode 902 to the expand mode 904. In contrast, based on the upward shake gesture, the pane modifier module 1134 can modify the plurality of the pane interface 218 in the expand mode 904 to the stack mode 902.

For another example, the pane modifier module 1134 can modify the pane interface 218 based on the gesture type 802, the display rule 510, or a combination thereof. The display rule 510 can indicate the interface type 206 to be displayed can base on the directionality of the gesture type 802 representing the pull gesture. For example, the display rule 510 can represent the pull gesture from the left extent towards the right extent of the display interface 204 can represent the displaying of the pane interface 218.

For another example, the pane modifier module 1134 can modify the pane interface 218 by minimizing the pane interface 218 into the pane indicator 710 or maximizing the pane indicator 710 into the pane interface 218. The pane modifier module 1134 can modify the pane interface 218 into the pane indicator 710 or vice versa based on receiving the gesture type 802 of the double tap gesture.

The physical transformation for determining the context 616 results in the movement in the physical world, such as people using the first device 102, based on the operation of the content delivery system 100. As the movement in the physical world occurs, the movement itself creates additional information that is converted back into updating the context 616, for updating the surface area size of the blade dimension 210 of the blade interface 202 that is displayable on the display interface 204 for the continued operation of the content delivery system 100 and to continue movement in the physical world.

The first software 1026 of FIG. 10 of the first device 102 of FIG. 10 can include the content delivery system 100. For example, the first software 1026 can include the surrounding module 1102, the blade module 1108, the group module 1120, the display module 1122, and the receiver module 1126.

The first control unit 1012 of FIG. 10 can execute the first software 1026 for the surrounding module 1102 to determine the context 616. The first control unit 1012 can execute the first software 1026 for the blade module 1108 to provide the blade interface 202. The first control unit 1012 can execute the first software 1026 for the group module 1120 to generate the interface group 702. The first control unit 1012 can execute the first software 1026 for the display module 1122 to display, modify, or a combination thereof of the blade interface 202. The first control unit 1012 can execute the first software 1026 for receiver module 1126 to receive the gesture type 802.

The second software 1042 of FIG. 10 of the second device 106 of FIG. 10 can include the content delivery system 100. For example, the second software 1042 can include the surrounding module 1102, the blade module 1108, the group module 1120, the display module 1122, and the receiver module 1126.

The second control unit 1034 of FIG. 10 can execute the second software 1042 for the surrounding module 1102 to determine the context 616. The second control unit 1034 can execute the second software 1042 for the blade module 1108 to provide the blade interface 202. The second control unit 1034 can execute the second software 1042 for the group module 1120 to generate the interface group 702. The second control unit 1034 can execute the second software 1042 for the display module 1122 to display, modify, or a combination thereof of the blade interface 202. The second control unit 1034 can execute the second software 1042 for receiver module 1126 to receive the gesture type 802.

The content delivery system 100 can be partitioned between the first software 1026 and the second software 1042. For example, the second software 1042 can include the surrounding module 1102, the blade module 1108, and the group module 1120. The second control unit 1034 can execute modules partitioned on the second software 1042 as previously described.

The first software 1026 can include the display module 1122 and the receiver module 1126. Based on the size of the first storage unit 1014, the first software 1026 can include additional modules of the content delivery system 100. The first control unit 1012 can execute the modules partitioned on the first software 1026 as previously described.

The first control unit 1012 can operate the first communication unit 1016 of FIG. 10 to send the gesture type 802 to the second device 106. The first control unit 1012 can operate the first software 1026 to operate the location unit 1020. The second communication unit 1036 of FIG. 10 can send the blade interface 202 to the first device 102 through the communication path 104 of FIG. 10.

The content delivery system 100 describes the module functions or order as an example. The modules can be partitioned differently. For example, the display module 1122 and the receiver module 1126 can be combined. Each of the modules can operate individually and independently of the other modules. Furthermore, data generated in one module can be used by another module without being directly coupled to each other. For example, the display module 1122 can receive the context 616 from the surrounding module 1102.

The modules described in this application can be hardware circuitry, hardware implementation, or hardware accelerators in the first control unit 1012 or in the second control unit 1034. The modules can also be hardware circuitry, hardware implementation, or hardware accelerators within the first device 102 or the second device 106 but outside of the first control unit 1012 or the second control unit 1034, respectively.

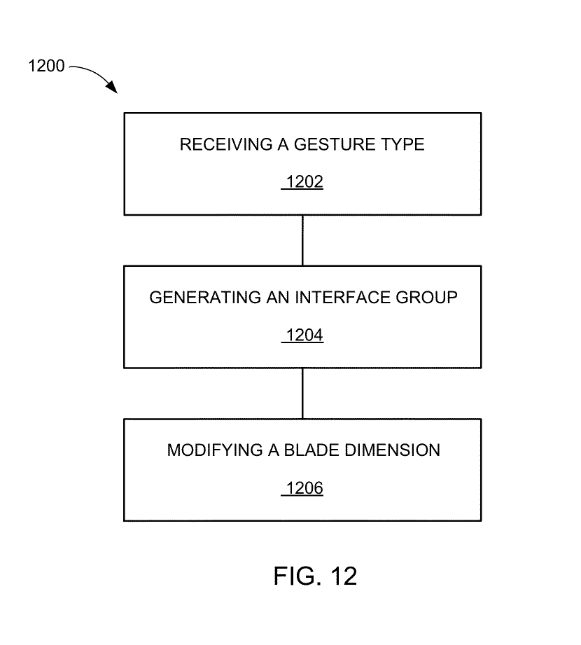

Referring now to FIG. 12, therein is shown a flow chart of a method 1200 of operation of a content delivery system 100 in an embodiment of the present invention. The method 1200 includes: receiving a gesture type on a blade interface in a block 1202; generating an interface group based on an interface type of the blade interface in a block 1204; and modifying a blade dimension of the blade interface based on the gesture type with a control unit for displaying on a device in a block 1206.

It has been discovered that the content delivery system 100 overlapping of the background interface of FIG. 2, the pane interface of FIG. 2, the menu interface of FIG. 2, or a combination thereof to create a blade non-right angle of FIG. 2 can improve the visibility of the content type of FIG. 2 displayed on the display interface of FIG. 2. By overlapping a plurality of the blade interface 202 one another to create the blade non-right angle 226, the content delivery system 100 can maximize the displayable surface area of the blade dimension of FIG. 2 for the blade interface 202. As a result, the user can perform the gesture type 802 of FIG. 8 more accurately for enhancing the user experience of operating the content delivery system 100, the first device 102 of FIG. 1, or a combination thereof.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the embodiment of the present invention is that it valuably supports and services the historical trend of reducing costs, simplifying systems, and increasing performance. These and other valuable aspects of the embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A content delivery system comprising:
a background provider module configured to provide a background interface;
a pane provider module, coupled to the background provider module, configured to provide a pane interface having a non-horizontal slant side overlapping the background interface; and
a menu provider module, coupled to the pane provider module, configured to provide a menu interface having a slant menu side overlapping the non-horizontal slant side of the pane interface creating a blade non-right angle for displaying on a device.

2. The system as claimed in claim 1 wherein the pane provider module is configured to provide the pane interface having a pane dimension different from another instance of the pane interface based on a content priority of a content type displayed on the pane interface.

3. The system as claimed in claim 1 further comprising an icon provider module, coupled to the pane provider module, configured to provide a feature icon on the menu interface based on an icon priority of the feature icon.

4. The system as claimed in claim 1 wherein the pane provider module is configured to provide the pane interface overlapping along the non-horizontal slant side of another instance of the pane interface.

5. The system as claimed in claim 1 further comprising a pane modifier module, coupled to the menu provider module, configured to modify a pane dimension of the pane interface based on a gesture type for providing a content preview.

6. The system as claimed in claim 1 further comprising a group module, coupled to the menu provider module, configured to generate an interface group based on grouping the background interface, the pane interface, the menu interface for displaying on the device.

7. The system as claimed in claim 6 further comprising a pane modifier module, coupled to the menu provider module, configured to modify the pane interface arranged from a stack mode to an expand mode or vice versa based on a gesture type.

8. The system as claimed in claim 6 further comprising a group module, coupled to the menu provider module, configured to generate an interface group based on grouping the background interface, the pane interface, the menu interface, or a combination thereof having an interface relationship.

9. The system as claimed in claim 6 further comprising a presenter module, coupled to the menu provider module, configured to change a pane dimension of the pane interface based on a context for displaying the pane interface on the device.

10. The system as claimed in claim 6 wherein the menu provider module is configured to provide a headline menu for displaying a feature icon based on an activity record.

11. A method of operation of a content delivery system comprising:
receiving a gesture type on a blade interface;
generating an interface group based on an interface type of the blade interface; and
modifying a blade dimension of the blade interface based on the gesture type with a control unit for displaying on a device.

12. The method as claimed in claim 10 wherein generating the interface group includes generating the interface group based on an interface relationship for associating a child interface with a parent interface.

13. The method as claimed in claim 10 wherein modifying the blade dimension includes modifying a pane dimension of a pane interface based on the gesture type for providing a content preview.

14. The method as claimed in claim 10 wherein modifying the blade dimension includes modifying a pane interface arranged from a stack mode to an expand mode or vice versa based on the gesture type.

15. The method as claimed in claim 10 wherein modifying the blade dimension includes modifying a menu dimension of a menu interface based on the gesture type for overlapping a pane interface, a background interface, or a combination thereof.

16. A content delivery system including an user interface comprising:
a background interface;
a pane interface having a non-horizontal slant side overlapping the background interface; and
a menu interface having a slant menu side overlapping the non-horizontal slant side of the pane interface creating a blade non-right angle for displaying on a device.

17. The user interface as claimed in claim 16 wherein the pane interface includes the pane interface overlapping along the non-horizontal slant side of another instance of the pane interface.

18. The user interface as claimed in claim 16 wherein the pane interface includes a content preview of the pane interface overlapping another instance of the pane interface unmodified by a gesture type.

19. The user interface as claimed in claim 16 wherein the pane interface includes a pane dimension of the pane interface extending from a top extent to a bottom extent of a display interface of the device.

20. The user interface as claimed in claim 16 wherein the menu interface includes a headline menu for displaying a feature icon based on an activity record.
